(19) United States
(12) Patent Application Publication
(10) Pub. No.: US 2016/0070288 A1
(43) Pub. Date: Mar. 10, 2016

(54) VOLTAGE GENERATION CIRCUIT

(71) Applicant: SHARP KABUSHIKI KAISHA, Osaka-shi, Osaka (JP)

(72) Inventor: Yoshiteru ISHIMARU, Osaka-shi (JP)

(73) Assignee: SHARP KABUSHIKI KAISHA, Osaka-shi, Osaka (JP)

(21) Appl. No.: 14/782,963

(22) PCT Filed: Jun. 11, 2014
(86) PCT No.: PCT/JP2014/065492

§ 371 Date: Oct. 7, 2015

(30) Foreign Application Priority Data
Jun. 12, 2013 (JP) 2013-123857

(51) Int. Cl. G05F 3/16

(52) U.S. Cl. CPC G05F 3/16

(57) ABSTRACT

Provided is a voltage generation circuit in which a power supply terminal 104 is connected to a voltage output terminal 105 through resistors 106 and 107. The voltage generation circuit includes a transistor 103, a transistor 109, and a transistor 111. A base and a collector of the transistor 103 are connected through a resistor 102 and an emitter is grounded. A base and a collector of the transistor 109 are connected through a resistor 108, the base is connected to the voltage output terminal 105, and an emitter of the transistor 109 is connected to the collector of the transistor 103. A base and a collector of the transistor 111 are connected through a resistor 110, the base is connected to a power supply terminal 117 through resistors 112 and 113, and an emitter of the transistor 111 is connected to the base of the transistor 103.

### TECHNICAL FIELD

The present invention relates to a voltage generation circuit having small dependency on power supply voltage.

### BACKGROUND ART

For example, a voltage generation circuit described in PTL 1 has been proposed as the voltage generation circuit in the related art. FIG. 17 is a circuit diagram of an example of the voltage generation circuit in the related art. As illustrated in FIG. 17, a voltage generation circuit 51 is a circuit in which transistors 52 and 53 are connected with resistors 54 and 55. In the voltage generation circuit 51, when a voltage is applied to a power supply terminal 56, summation of base-emitter voltages (Vbe) in the transistors 52 and 53, that is, an output voltage of two times Vbe is output to a voltage output terminal 57. In this voltage generation circuit 51, a value of a resistor 54 is changed, and thus the output voltage may be finely adjusted. For example, when a circuit is made as an integrated circuit, if the resistor 54 or a portion of the resistor 54 is configured with a chip resistor on the outside of an integrated circuit, the output voltage may be finely adjusted by changing a value thereof. The voltage generation circuit 51 has properties that “a voltage generated in the voltage output terminal becomes higher as a power supply voltage becomes higher” and has dependency, which is not small, of the output voltage on the power supply voltage.

A circuit which causes such dependency of the output voltage on the power supply voltage to be reduced will be described with reference to the accompanying drawings. FIG. 18 is a circuit diagram of another example of the voltage generation circuit in the related art. A voltage generation circuit 61 illustrated in FIG. 18 is obtained by adding a resistor 62 between a base terminal of the transistor 52 and the voltage output terminal 57 in the voltage generation circuit 51. Other than that, the voltage generation circuit 61 illustrated in FIG. 18 has a configuration similar to the voltage generation circuit 51, and substantially the same elements and terminals are denoted by the same reference signs.

In the voltage generation circuit 61, an action of voltage drop due to the resistor 62 causes an effect of “decreasing a voltage generated in the voltage output terminal in accordance with an increase of the power supply voltage” to occurs. Thus, a portion of properties of the voltage generation circuit 51, that is, the properties of “the voltage generated in the voltage output terminal increasing in accordance with an increase of the power supply voltage” is negated. It is possible to reduce power supply voltage dependency of an output voltage by this effect of the resistor 62. Alternatively, characteristics of the voltage generation circuit 61 may be adjusted such that an output voltage has the maximum value at the power supply voltage having a certain value and the output voltage turns to decreasing at the power supply voltage having a value equal to or more than the certain value. That is, the voltage generation circuit 61 is a circuit having reduced power supply voltage dependency of the output voltage in comparison to the voltage generation circuit 51. Particularly, the voltage generation circuit 61 becomes an excellent circuit which can be used as a voltage generation circuit having significantly small dependency on power supply voltage by using the circuit in the vicinity of the power supply voltage which causes the output voltage to have the maximum value.

A relationship between the output voltage and the power supply voltage in each of the voltage generation circuits 51 and 61 will be described below. FIG. 19 is a diagram illustrating the relationship between the output voltage and the power supply voltage in the voltage generation circuit. In FIG. 19, a graph curve 71 is a graph indicating the relationship between the output voltage (vertical axis) and the power supply voltage (horizontal axis) in the voltage generation circuit 51. A graph curve 72 is a graph indicating the relationship between the output voltage (vertical axis) and the power supply voltage (horizontal axis) in the voltage generation circuit 61. Simulation is performed by using a model of a circuit configuration of each of the voltage generation circuits 51 and 61, and thus values are calculated.

Regarding a resistance value of each resistor in the simulation, the resistor 54 is set to 3200Ω, the resistor 55 is set to 8000Ω, and the resistor 62 is set to 50Ω. The transistors 52 and 53 are set to be GaAs hetero-junction bipolar transistors and to have a size of an emitter being 48 μm².

As illustrated in FIG. 19, the output voltage (graph curve 71) of the voltage generation circuit 51 has characteristics of having a value gradually increasing with an increase of the power supply voltage (having high power supply voltage dependency). On the other hand, the output voltage (graph curve 72) of the voltage generation circuit 61 has the maximum value when the power supply voltage has a value in the vicinity of 4 V. In a range in which the power supply voltage having a value more than 4 V, when the power supply voltage increases, the output voltage decreases. That is, when the voltage generation circuit 61 is used with a power supply voltage having a value of the vicinity of 4 V, the voltage generation circuit 61 may be used as a circuit having low power supply voltage dependency of the output voltage.

### CITATION LIST

### Patent Literature

PTL 1: Japanese Patent No. 3847756

### SUMMARY OF INVENTION

### Technical Problem

FIG. 20 is a diagram illustrating a relationship between the output voltage and the power supply voltage when a value of a resistor is changed in the voltage generation circuit of the related art. A result illustrated in FIG. 20 is also a result obtained by circuit simulation similar to the above-described simulation.

In FIG. 20, a graph curve 81 is a graph illustrating a relationship between the output voltage (vertical axis) and the power supply voltage (horizontal axis) of the voltage generation circuit 51. Output voltages when a value of the resistor 54 is respectively set to 2200 Ω, 3200Ω, and 4200Ω are illustrated as three graphs with a dashed line in FIG. 20, and the three graphs are distinguished from each other by respectively attaching the resistance value of the resistor 54 to the graphs. A graph curve 82 is a graph illustrating a relationship between the output voltage (vertical axis) and the power supply voltage (horizontal axis) of the voltage generation circuit 61. Output voltages when a value of the resistor 54 is respectively set to 2200Ω, β200 Ω, and 4200Ω are illustrated as three graphs with a solid line in FIG. 20, and the three graphs are distinguished from each other by respectively attaching the resistance value of the resistor 54 to the graphs.

The output voltage (graph curve 81) of the voltage generation circuit 51 becomes higher if the value of the resistor 54 becomes smaller. As described above, the above-described characteristics of the voltage generation circuit 51 are exemplified; that is, for example, the output voltage can be finely adjusted by using a simple method of changing the value of the resistor 54.

On the other hand, regarding the output voltage (graph curve 82) of the voltage generation circuit 61, power supply voltage dependency is changed such that, when the value of the resistor 54 is smaller, the power supply voltage which causes the output voltage to have the maximum value is shifted to be high and the maximum value of the output voltage is substantially not changed. That is, in the voltage generation circuit 61, when a circuit is designed by adjusting the circuit such that the maximum value of the output voltage is obtained in the vicinity of the power supply voltage to be used, if the output voltage is finely adjusted by, as in the circuit 51, using the value of the resistor 54, the characteristics of low power supply voltage dependency which is intended may be deteriorated.

In the voltage generation circuit 61, a change of a voltage of a base electrode of the transistor 52 (substantially the same value as the output voltage of the voltage generation circuit 51, and about 2.4 V to 2.6 V) is small (about 0.2 V) against an increase of the power supply voltage and is substantially not changed in comparison to the increase of the power supply voltage, in a power supply voltage range of about 2.5 V or higher in which the electricity is conducted through the transistors 52 and 53. Accordingly, most of an increased amount of the power supply voltage corresponds to an increased amount of a voltage across terminals of the resistor 54, and a current flowing in the resistor 54 is increased in proportion to the increase of the power supply voltage, in accordance with an inverse number of the value of the resistor 54.

Since a current flowing in a base of the transistor 52 is small and the current flowing in the resistor 54 mainly flows in the resistor 62, voltage drop in the resistor 62 is also increased in proportion to the power supply voltage. That is, the power supply voltage dependency of the output voltage of the voltage generation circuit 61 is suppressed so as to be low in such a manner that an amount of voltage drop in the resistor 62 is changed substantially in proportion to an expression of (change of the power supply voltage)*(resistance value of the resistor 62)/(resistance value of the resistor 54), and thus a gradual increase of the voltage of the base terminal of the transistor 52 in accordance with the increase of the power supply voltage is suppressed. Accordingly, if the value of the resistor 54 in the voltage generation circuit 61 is changed, the power supply voltage dependency is changed in addition to the output voltage.

For example, in a case where both of the resistor 54 and the resistor 62 are formed of chip resistors on the outside of an integrated circuit, obviously the power supply voltage dependency may be held, and a value of the output voltage may be adjusted, but it is necessary that resistance values of two resistors are adjusted with a certain proportion. Accordingly, it is not practical.

If the resistors 54 and 62 are formed in the integrated circuit, the two resistors are formed by the same process, and thus it may be relatively easy to accurately hold proportions of values of the two resistors. However, in a case where one or both of the resistors are realized as chip resistors on the outside of an integrated circuit, element variation of the chip resistor has an influence on characteristics of the circuit and thus an use for a product is difficult.

An object of the present invention is to provide a voltage generation circuit which has a simple configuration and has low dependency of an output voltage on a power supply voltage, and thus can adjust the output voltage with suppression of a change of the dependency on the power supply voltage.

### Solution to Problem

To achieve the above object, the present invention provides a voltage generation circuit including: a first power supply terminal; a first voltage output terminal; a first resistor; a first bipolar transistor; a first circuit; and a second circuit. An emitter terminal of the first bipolar transistor is connected to a ground terminal, a base terminal and a collector terminal of the first bipolar transistor are connected to each other by a first connection path, and a first connection terminal is provided on the first connection path, a first terminal of the first circuit is connected to the first power supply terminal through the first resistor; a second terminal of the first circuit is connected to the first connection path between the first connection terminal and the collector terminal of the first bipolar transistor, a resistor is provided on the first connection path between the second terminal of the first circuit and the first connection terminal. The first circuit is one of a circuit which has a diode and generates a forward junction voltage of diode junction between the first terminal of the first circuit and the second terminal of the first circuit in accordance with a current flowing in the diode, and a circuit which has a bipolar transistor of which a base and a collector are connected to each other and generates a forward junction voltage of a base-emitter junction between the first terminal of the first circuit and the second terminal of the first circuit in accordance with an emitter current. A first terminal of the second circuit is connected to one of the first power supply terminal and a power supply terminal having the same potential as the first power supply terminal. A second terminal of the second circuit is connected to the first connection terminal. The second circuit is one of a circuit which has a diode and a second resistor and generates summation of a forward junction voltage of diode junction and voltage drop by the second resistor between the first terminal of the second circuit and the second terminal of the second circuit in accordance with a current flowing in the diode, and a circuit which has a bipolar transistor of which a base and a collector are connected to each other and a second resistor and generates summation of a forward junction voltage of a base-emitter junction and voltage drop by the second resistor between the first terminal of the second circuit and the second terminal of the second circuit in accordance with an emitter current. In the voltage generation circuit, connection is performed such that a polarity of the base-emitter junction in the first bipolar transistor has a forward direction for the power supply voltage of the power supply terminal, and the voltage output terminal is connected to the first terminal of the first circuit.

### Advantageous Effects of Invention

According to the present invention, it is possible to provide a voltage generation circuit which has a simple configuration and low dependency of the output voltage on the power supply voltage, and thus can adjust the output voltage with suppression of a change of the dependency on the power supply voltage.

### BRIEF DESCRIPTION OF DRAWINGS

FIG. 1 is a circuit diagram illustrating an example of a voltage generation circuit according to the present invention.

FIG. 2 is a diagram illustrating a relationship between an output voltage and a power supply voltage in the voltage generation circuit according to the present invention.

FIG. 3 is a diagram illustrating a relationship between a collector voltage of a first bipolar transistor and the power supply voltage, and a relationship between a base-emitter voltage of a transistor in a first circuit and the power supply voltage.

FIG. 4 is a diagram illustrating a relationship between a current flowing in a bipolar transistor and the power supply voltage.

FIG. 5 is a diagram in which a base voltage of a fourth bipolar transistor is compared with an output voltage of a voltage generation circuit in the related art.

FIG. 6 is a circuit diagram illustrating another example of the voltage generation circuit according to the present invention.

FIG. 7 is a circuit diagram illustrating yet another example of the voltage generation circuit according to the present invention.

FIG. 8 is a circuit diagram illustrating yet another example of the voltage generation circuit according to the present invention.

FIG. 9 is a diagram illustrating a relationship between an output voltage and the power supply voltage of the voltage generation circuit illustrated in FIG. 6.

FIG. 10 is a diagram illustrating a relationship between an output voltage and the power supply voltage of the voltage generation circuit illustrated in FIG. 7.

FIG. 11 is a diagram illustrating a relationship between an output voltage and the power supply voltage of the voltage generation circuit illustrated in FIG. 8.

FIG. 12 is a diagram obtained by enlarging peak portions of the output voltage in the voltage generation circuits illustrated in FIGS. 6, 7, 8, and 1.

FIG. 13 is a circuit diagram illustrating an example of a power amplification circuit using the voltage generation circuit according to the present invention.

FIG. 14 is a diagram illustrating connection portions with terminals of the first bipolar transistor, a second bipolar transistor, and the fourth bipolar transistor in the voltage generation circuit illustrated in FIG. 1.

FIG. 15A is a diagram illustrating yet another example of the voltage generation circuit according to the present invention.

FIG. 15B is an example of an equivalent circuit of the voltage generation circuit illustrated in FIG. 15A

FIG. 15C is other example of an equivalent circuit of the voltage generation circuit illustrated in FIG. 15A

FIG. 15D is other example of an equivalent circuit of the voltage generation circuit illustrated in FIG. 15A

FIG. 16 is a circuit diagram illustrating a modification example of the voltage generation circuit illustrated in FIG. 8.

FIG. 17 is a circuit diagram illustrating an example of a voltage generation circuit in the related art.

FIG. 18 is a circuit diagram illustrating another example of a voltage generation circuit in the related art.

FIG. 19 is a diagram illustrating a relationship between an output voltage and a power supply voltage in the voltage generation circuits in the related art.

FIG. 20 is a diagram illustrating a relationship between the output voltage and the power supply voltage when a value of a resistor is changed in the voltage generation circuits in the related art.

### DESCRIPTION OF EMBODIMENTS

Hereinafter, embodiments according to the present invention will be described with reference to the accompanying drawings. In the following embodiments, a circuit configuration example in which a power supply voltage applied to a power supply terminal has a positive value and NPN type bipolar transistors are included will be described. However, it is not limited thereto. For example, the similar circuit configuration may be obtained by using PNP type bipolar transistors and the similar effects may be obtained by the power supply voltage and an output voltage having a negative value. In that case, in the subsequent descriptions, when values of the voltage or values of the current are compared, such values are taken as absolute values of the voltage or absolute values of the current, and an anode terminal and a cathode terminal in electrodes of a diode are considered reversely.

In the following embodiments, parts and terminals of the same configuration are denoted by the same reference signs. Thus, the drawings illustrating characteristics illustrate results obtained by simulation calculation, by applying the same element value to components having the same reference signs unless otherwise described. When there is no particular description, GaAs hetero-junction bipolar transistors having a size of an emitter area of 48 μm² are used as transistors. When transistors having different sizes are used, each of the transistors is represented by a ratio of an emitter area to the size (48 μm²).

### First Embodiment

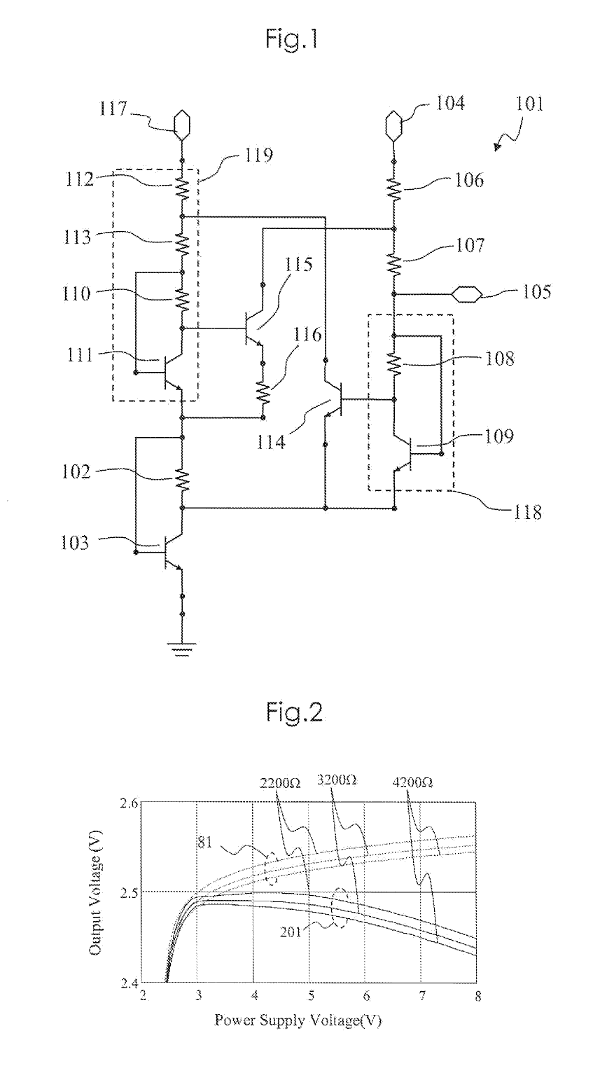

FIG. 1 is a circuit diagram illustrating an example of a voltage generation circuit according to the present invention. As illustrated in FIG. 1, a voltage generation circuit 101 has power supply terminals 104 and 117, and a voltage output terminal 105. The power supply terminal 104 is connected to the voltage output terminal 105 by using a resistor 106 and a resistor 107. The voltage generation circuit 101 has a transistor 103 of which a base terminal and a collector terminal are connected to each other by using a resistor 102 and an emitter terminal is grounded.

The voltage generation circuit 101 has a transistor 109 of which a base terminal and a collector terminal are connected to each other by using a resistor 108. The base terminal of the transistor 109 is connected to the voltage output terminal 105 and an emitter terminal of the transistor 109 is connected to the collector terminal of the transistor 103. The voltage generation circuit 101 has a transistor 111 of which a base terminal and a collector terminal are connected to each other by using a resistor 110. The base terminal of the transistor 111 is connected to the power supply terminal 117 by using a resistor 112 and a resistor 113. An emitter terminal of the transistor 111 is connected to the base terminal of the transistor 103.

Here, the power supply terminal 104 is a first power supply terminal and the power supply terminal 117 is a power supply terminal having the same potential as the first power supply terminal. The voltage output terminal 105 is a first voltage output terminal. The resistor 106 and the resistor 107 are a first resistor, and the resistor 112 and the resistor 113 are a second resistor. The transistor 103 is a first bipolar transistor.

A path from the base terminal of the transistor 103 being the first bipolar transistor to the collector terminal of the transistor 103 via the resistor 102 is a first connection path. A location (base terminal of the transistor 103) on the first connection path, to which the emitter terminal of the transistor 111 is connected, is set as a first connection terminal.

The transistor 109 of which a base and a collector are connected to each other by using the resistor 108 constitutes a first circuit 118 indicated by a dashed line. The first circuit 118 is connected such that between a first terminal connected to the voltage output terminal 105 and a second terminal connected to the collector terminal of the transistor 103, a junction voltage of a forward base-emitter junction is generated in accordance with an emitter current.

The transistor 111 of which a base and a collector are connected to each other by using the resistor 110, the resistor 112, and the resistor 113 constitute a second circuit 119 indicated by a dashed line. The second circuit is connected such that between a first terminal connected to the power supply terminal 117 and a second terminal connected to the first connection terminal (base terminal of the transistor 103), summation of a junction voltage of a forward base-emitter junction and voltage drop by the resistor 112 and the resistor 113 is generated in accordance with an emitter current of the transistor 111.

Further, connection is performed such that a polarity of the base-emitter junction of the transistor 103 has a forward direction against a voltage at the power supply terminal 104.

The voltage generation circuit 101 further includes a transistor 114. A base terminal of the transistor 114 is connected to the collector terminal of the transistor 109 and an emitter terminal of the transistor 114 is connected to the collector terminal of the transistor 103. A collector terminal of the transistor 114 is connected to the power supply terminal 117 through the resistor 112.

Here, the transistor 109 is a second bipolar transistor and the transistor 114 is a third bipolar transistor. The transistor 109 is used as a transistor element of the first circuit and also as the second bipolar transistor.

A path from the base terminal of the transistor 109 being the second bipolar transistor to the collector terminal of the transistor 109 via the resistor 108 is a second connection path. A location (base terminal of the transistor 109) on the second connection path, to which the resistor 107 is connected, is set as a second connection terminal.

A path from the collector terminal of the transistor 114 to the power supply terminal 117 via the resistor 112 is a path in which resistive elements such as the resistor 106 and the resistor 107 each being the first resistor, are not included. The resistor 106 and the resistor 107 are resistive elements in which a collector current of the transistor 114 does not flow.

Further, connection is performed such that both of a polarity of a base-emitter junction in the second bipolar transistor and a polarity of a base-emitter junction in the third bipolar transistor have a forward direction against the voltage at the power supply terminal 104.

In the voltage generation circuit 101, the resistor 112 which connects the collector terminal of the transistor 114 to the power supply terminal 117 is set as a portion of the second resistor (resistor 112 and resistor 113), that is, set as a common resistor. The resistor 112 being the common resistor is a third resistor.

The voltage generation circuit 101 further includes a transistor 115. A base terminal of the transistor 115 is connected to the collector terminal of the transistor 111 and an emitter terminal of the transistor 115 is connected to the base terminal of the transistor 103 through the resistor 116. A collector terminal of the transistor 115 is connected to the power supply terminal 104 through the resistor 106.

The resistor 106 is set as a portion of the first resistor (resistor 106 and resistor 107) which connects the power supply terminal 104 to the voltage output terminal 105, that is, the resistor 106 is set as a common resistor.

Here, the transistor 111 is a fourth bipolar transistor and the transistor 115 is a fifth bipolar transistor. The resistor 106 being the common resistor is a fourth resistor.

The transistor 111 is used as a transistor of the second circuit and also as the fourth bipolar transistor.

A path from the base terminal of the transistor 111 being the fourth bipolar transistor to the collector terminal of the transistor 111 via the resistor 110 is a third connection path. A location (base terminal of the transistor 111) on the third connection path, which is connected to the power supply terminal 117 by using the resistors 112 and 113 is set as a third connection terminal. Connection of the fourth bipolar transistor and the fifth bipolar transistor in the voltage generation circuit 101 is performed such that both of a polarity of a base-emitter junction in the fourth bipolar transistor and a polarity of a base-emitter junction in the fifth bipolar transistor have a forward direction against the voltage at the power supply terminal 104.

In the following descriptions, in order to demonstrate an operation of the voltage generation circuit 101, simulation is performed by using a model of the circuit configuration in FIG. 1, and thus a value of an output voltage and the like are calculated. In the simulation, the resistor 102 is set as 180Ω, the resistor 107 is set as 1500Ω, and the resistor 108 is set as 390Ω. The resistor 110 is set as 160Ω, the resistor 112 is set as 3500Ω, the resistor 113 is set as 2000Ω, and the resistor 116 is set as 250Ω. Only the transistor 114 is an element having a seven times emitter size. The voltage at the power supply terminals 104 and 117 are set to have the same potential.

FIG. 2 is a diagram illustrating a relationship between an output voltage and a power supply voltage in the voltage generation circuit according to the present invention. In the graph of FIG. 2, a graph curve 201 is a graph illustrating the relationship between the output voltage (vertical axis) and the power supply voltage (horizontal axis) in the voltage generation circuit 101. For the graph curve 201, FIG. 2 illustrates voltages when a resistance value of the resistor 106 is respectively set to 2200 Ω, 3200Ω, and 4200Ω, as three graphs. In FIG. 2, the three graphs are distinguished from each other by attaching the resistance value of the resistor 106 to the corresponding graph. For comparison, FIG. 2 illustrates a graph illustrating a relationship between an output voltage (vertical axis) and a power supply voltage (horizontal axis) in the voltage generation circuit 51 of the related art, as a graph curve 81. For the graph curve 81, FIG. 2 illustrates voltages when a resistance value of the resistor 54 is respectively set to 2200 Ω, 3200Ω, and 4200Ω, as three graphs. In FIG. 2, the three graphs are distinguished from each other by attaching the resistance value of the resistor 54 to the corresponding graph.

As illustrated in FIG. 2, the output voltage (graph curve 201) of the voltage generation circuit 101 increases based on an increase of the power supply voltage and has the maximum value when the power supply voltage has about 4 V. Then, as the power supply voltage increases, the output voltage decreases. When the resistance value of the resistor 106 is changed, the graph curve moves in an up-and-down direction without a substantial change of a curve shape. Thus, it is found that the voltage generation circuit 101 has a power supply voltage range in which dependency on power supply voltage is low and that the output voltage can be adjusted such that the power supply voltage dependency is not greatly changed by changing the resistance value of the resistor 106.

Next, an operation of the voltage generation circuit described in this embodiment will be described with reference to the accompanying drawings. First, voltage drop occurring by the resistor 102 is ignored, and it is assumed that the base terminal and the collector terminal of the transistor 103 have the same potential. When the voltage at the power supply terminal 104 gradually increases on this assumption, the transistor 109 and transistor 103 have total two base-emitter junctions between the voltage output terminal 105 and a ground terminal (emitter terminal of the transistor 103). Thus, when the power supply voltage applied to the power supply terminal 104 increases up to a voltage of about 2.5 V which causes both the two base-emitter junctions to be conducted, a current starts to flow in the circuit. In the power supply voltage range of about 2.5 V or higher, a base-emitter voltage in the transistors 109 and 103 are not much changed, and a voltage corresponding to an increased amount of the power supply voltage is mainly applied to the resistors 106 and 107, similarly to the voltage generation circuits 51 and 61 in the related art. The circuit operates such that a current flowing in the resistors 106 and 107 is increased substantially in proportion to the increase of the power supply voltage.

In a typical transistor, a base current increases rapidly with an increase of a base-emitter voltage, like an exponential function. When a necessary collector voltage is applied, a collector current which is β (current amplification factor) times the base current flows. That is, the collector current also increases rapidly with an increase of a base-emitter voltage, like an exponential function. Conversely, considering the base current and the collector current as a reference, the base-emitter voltage increases with algebraic tardiness even though the current increases. With this characteristic, even though a current flowing in the resistors 106 and 107 increases substantially in proportion to the increase of the power supply voltage of the power supply terminal 104, the base-emitter voltage (Vbe) changes algebraically, that is, tardily.

As described above, a voltage at the voltage output terminal 105 is a voltage corresponding to the two base-emitter junctions. From this, a voltage at the voltage output terminal 105 which “corresponds to the voltage corresponding to the two base-emitter junctions considering that the voltage drop occurring by the resistor 102 is ignored” shows “properties of a gradual increase of a reference voltage generated at the voltage output terminal in accordance with an increase of the power supply voltage”.

Then, a case in which a voltage at the power supply terminal 117 which has the same potential as the power supply terminal 104 is increased along with the voltage at the power supply terminal 104 is considered. When the increased voltage reaches a voltage of about 2.5 V which causes both two base-emitter junctions in the transistor 111 and the transistor 103 to be conducted, a current starts to flow in a circuit from the power supply terminal 117 to the transistor 103. In the power supply voltage range of about 2.5 V or higher, similarly, the circuit is operated such that increasing of a current flowing in the resistors 112 and 113 and an emitter current of the transistor 111 in proportion to the increase of the power supply voltage is difficult.

Since the transistor 103 has the small base current, the emitter current of the transistor 111 mainly flows in the resistor 102 and then flows into the collector terminal of the transistor 103. Thus, voltage drop due to the resistor 102 is increased in proportion to an increase of the current. Since an emitter of the transistor 109 is connected to a terminal (collector terminal of the transistor 103) at which the voltage drop has been occurred in the resistor 102, if it is considered that the voltage drop in the resistor 102 which has been ignored ahead to this is also included, a process of “decreasing a voltage generated at the voltage output terminal in accordance with the increase of the power supply voltage” is performed at the voltage output terminal 105 by an action of the voltage drop in the resistor 102.

Here, a “voltage generation circuit in which the increase of the output voltage occurring in accordance with the increase of the power supply voltage”, and a “voltage generation circuit which generates a voltage such that the output voltage reaches a voltage having the maximum value once and then turns to decreasing in accordance with the increase of the power supply voltage” by using a balance between the process and the above-described “properties of a gradual increase of a reference voltage generated at the voltage output terminal in accordance with an increase of the power supply voltage”.

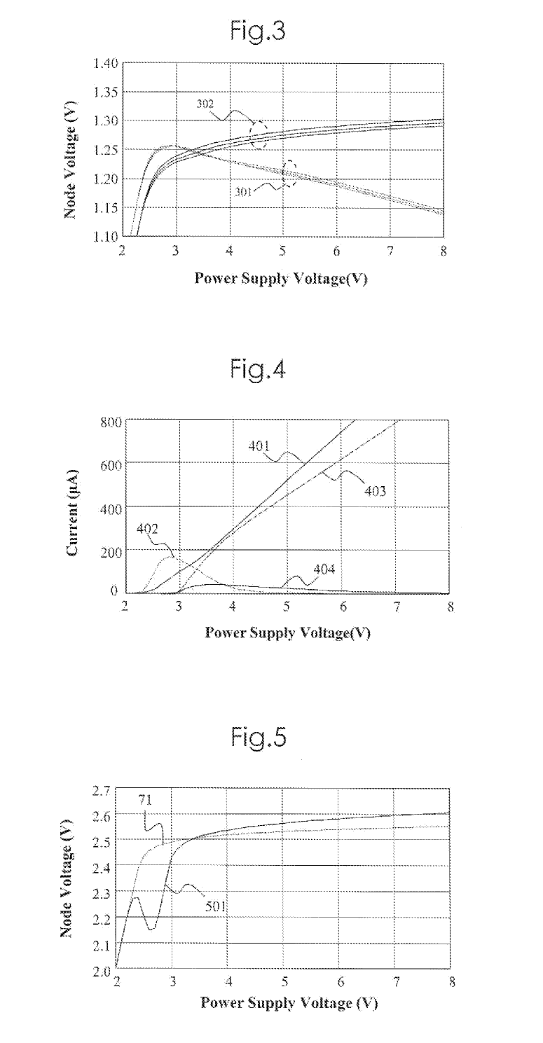

The operation of the voltage generation circuit will be described further. FIG. 3 is a diagram illustrating a relationship between the collector voltage of the first bipolar transistor and the power supply voltage, and a relationship between the base-emitter voltage of the transistor in the first circuit and the power supply voltage. In FIG. 3, a graph curve 301 is a graph illustrating the relationship between the collector voltage (vertical axis) of the transistor 103 being the first bipolar transistor and the power supply voltage (horizontal axis). For the graph curve 301, FIG. 3 illustrates voltages when a resistance value of the resistor 106 is respectively set to 2200 Ω, 3200Ω, and 4200Ω, as three graphs. A graph curve 302 is a graph illustrating the relationship between the base-emitter voltage (vertical axis) of the transistor 109 being the second bipolar transistor and the power supply voltage (horizontal axis). For the graph curve 302, FIG. 3 illustrates voltages when a resistance value of the resistor 106 is respectively set to 2200 Ω, 3200Ω, and 4200Ω, as three graphs. In the graph curve 302, the resistance value of the resistor 106 corresponds to 2200 Ω, 3200Ω, and 4200Ω in an order from above. In the graph curve 301, since the three graphs are mixed with a slight difference, the three graphs are particularly distinguished from each other, that is, a state of a small difference is illustrated.

As described above, summation of the collector voltage (graph curve 301) of the transistor 103 and the base-emitter voltage (graph curve 302) of the transistor 109 becomes the output voltage (graph curve 201 in FIG. 2) of the voltage generation circuit 101. As illustrated in FIG. 3, when the value of the resistor 106 is changed, the base-emitter voltage (graph curve 302) of the transistor 109 is subjected to parallel transference in a longitudinal direction of the graph in a state where a shape of the curve is not changed much. The collector voltage (graph curve 301) of the transistor 103 has a little change, and a gap between the three lines of the graph curve 301 is narrower than that of the graph curve 302.

As known by using these results, the output voltage (graph curve 201 in FIG. 2) is mainly changed by the base-emitter voltage (graph curve 302) of the transistor 109 when the value of the resistor 106 is changed. The base-emitter voltage (graph curve 302) of the transistor 109 has a voltage value which is changed with the power supply voltage dependency which is substantially held. Thus, it is considered that a little change in the power supply voltage dependency of the output voltage (graph curve 201) does not appear and the output voltage is changed.

That is, in the voltage generation circuit 61 of the related art, a current which is changed by changing the resistance value of the resistor 54 flows in the resistor 62 serving as an action of voltage drop. Thus, it is considered that a large influence by the voltage drop in the resistor 62 appears and thus the power supply voltage dependency is largely changed. In the voltage generation circuit 101 according to this embodiment, a current which flows in the resistor 102 and causes the voltage drop to occurs mainly depends on another path (resistors 112 and 113, and transistor 111), and is schematically determined by a resistance ratio of the second resistor (112 and 113) and the resistor 102. This is known from that a little change of the graph curve 301 in FIG. 3, that is, a little change of the collector voltage of the transistor 103 on which the voltage drop in the resistor 102 has an influence.

Accordingly, it is considered that even though the resistance value of the resistor 106 being the first resistor is changed, the current flowing in the resistor 102 is not largely changed, the voltage drop in the resistor 102, that is, the power supply voltage dependency of the output voltage is a little changed. In the voltage generation circuit 101 according to this embodiment, the above actions allow the output voltage to be adjusted without a large change of the power supply voltage dependency by using the resistor 106.

If the second resistor (112 and 113), and the resistor 102 in the voltage generation circuit 101 are formed in an integrated circuit, both of the resistors are formed by using the same process. Thus, it may be relatively easy to hold a ratio of values of the resistors with accuracy. Accordingly, if the resistor 106 or a portion of the resistor 106 is disposed on the outside of the integrated circuit in a state where advantages of small variation in manufacturing, which relates to the power supply voltage dependency of the output voltage, it is possible to provide a practical voltage generation circuit in which the output voltage may be adjusted as necessary.

A detailed configuration of the voltage generation circuit 101 will be described below. In the voltage generation circuit 101 illustrated in FIG. 1, the transistor 111 may be not necessarily required. That is, even though only the resistors 112 and 113 are connected to the base terminal of the transistor 103 from the power supply terminal 104, if the power supply voltage increases, the similar action which causes the current to increase, causes the voltage drop in the resistor 102 to increase, and causes the output voltage to decrease occurs. Thus, the transistor 111 may be considered to be unnecessary.

Since Vbe is changed a little against a change of the power supply voltage, if Vbe is considered to be constant, an amount of the change of the voltage drop in the resistor 102 against an amount of the change of the power supply voltage is represented by the following (Expression 1) and is the same regardless of whether or not there is the transistor 111.

(An amount of the change of the voltage drop in the resistor 102 against an amount of the change of the power supply voltage)=(resistance value of resistor 102)/(summation value of resistance values of resistors 112 and 113). (Expression 1)

However, when the transistor 111 is not included, a voltage corresponding to the Vbe is additionally applied to the resistors 112 and 113. Thus, even though the same power supply voltage is applied, the current increases, and a value (absolute amount, not amount of a change) of the voltage drop in the resistor 102 becomes greater. The bipolar transistor has characteristics of performing a transistor operation (amplification operation) even though a collector-emitter voltage is slightly less than the base-emitter voltage. Thus, the voltage generation circuit 101 has a circuit configuration in which only the voltage drop in the resistor 102 causes the collector voltage of the transistor 103 to be less than the base voltage. However, if the collector-emitter voltage becomes excessively low, it is impossible to perform the transistor operation (amplification operation) and thus it is impossible that the voltage drop in the resistor 102 becomes very large.

For example, in a circuit configuration in which the transistor 111 is not included, it is assumed that an increasing value of the voltage drop is suppressed by decreasing a flowing current. In this case, if the resistors 112 and 113 have a large value in order to decrease the current, a value of the denominator on the right side of Expression 1 becomes greater, and “the amount of the change of the voltage drop in the resistor 102 against the amount of the change of the power supply voltage” on the left side becomes smaller. Thus, actions for decreasing the output voltage are insufficient. In order to compensate insufficiency of the action, if a resistance value of the resistor 102 which is the numerator on the right side, even though the current becomes small, an absolute amount of the value of the voltage drop in the resistor 102 is not reduced.

In the circuit configuration in which the transistor 111 is not included, it is assumed that an increasing value of the voltage drop is suppressed by reducing the value of the resistor 102. In this case, “the amount of the change of the voltage drop in the resistor 102 against the amount of the change of the power supply voltage” on the left side in Expression 1 also becomes smaller, and the actions for decreasing the output voltage are also insufficient.

That is, a configuration in which a current starts to flow in the resistor 102 from a voltage close to the output voltage is used as a circuit configuration having a substantial effect. Thus, it is possible to cause the value of the voltage drop in the resistor 102 to become sufficiently small, and cause the amount of the change to be increased up to an extent of allowing the effect to be obtained.

In the voltage generation circuit 101, since the output voltage is a voltage (summation of Vbe of the transistor 103 and Vbe of the transistor 109) of substantially two times Vbe, it is known that the transistor 111 is required such that the current flowing in the resistance value of the resistor 102 has a value of the vicinity of a voltage of two times Vbe and starts to flow. According to the above descriptions, Vbe of the transistor 111 and Vbe of the transistor 109 may have values close to each other, but it is not necessary that all of the values are the same as each other. A configuration in which the power supply voltage which causes the currents of the transistor 111 and the transistor 109 to start to flow is intentionally shifted may be obtained by forming different Vbe by using different junction materials. In practice, as will be described later, the configuration in which the power supply voltage which causes the currents of the transistor 111 and the transistor 109 to start to flow is shifted is applied.

The voltage generation circuit 101 according to the present invention further includes the transistor 114 being the third bipolar transistor. An action of the transistor 114 will be described with reference to the accompanying drawing. FIG. 4 is a diagram illustrating a relationship between a current flowing in the bipolar transistor and the power supply voltage.

In FIG. 4, graph curves 401, 402, 403, and 404 are graphs illustrating the following values. The graph curve 401 is a graph illustrating a relationship between an emitter current (vertical axis) of the transistor 109 (second bipolar transistor) and the power supply voltage (horizontal axis). The graph curve 402 is a graph illustrating a relationship between an emitter current (vertical axis) of the transistor 114 (third bipolar transistor) and the power supply voltage (horizontal axis). The graph curve 403 is a graph illustrating a relationship between an emitter current (vertical axis) of the transistor 111 and the power supply voltage (horizontal axis). The graph curve 404 is a graph illustrating a relationship between an emitter current (vertical axis) of the transistor 115 and the power supply voltage (horizontal axis). The graph curves 403 and 404 are used in the description which will be made later. Each of the graphs in FIG. 4 illustrates a result obtained by performing simulation calculation when the resistance value of the resistor 106 is set to 3200 Ω.

In an operation of a transistor, a base current is smaller than a collector current and an emitter current, and the collector current and the emitter current may be considered to have substantially the same value. Thus, descriptions will be made below by setting the collector current and the emitter current to have the same value, and by using the same graph (graph curves 401, 402, 403, and 404).

As described above, the transistor 109 causes the current to start to flow when the voltages of the power supply terminals 104 and 117 are in the vicinity of the voltage (2.5 V) of two times Vbe. Since voltage drop occurring by the resistor 108 may be ignored while the current is small, the transistor 114 also causes the current to start to flow. The emitter current (graph curve 402) of the transistor 114 is supplied to the transistor 103 along with the emitter current (graph curve 401) of the transistor 109. Thus, a value of the emitter current (graph curve 401) of the transistor 109, which flows into the same terminal is relatively reduced. As a result, an action in such a manner that voltage drop in the resistors 106 and 107 in which the collector current (≈ emitter current) (graph curve 401) of the transistor 109 flows is reduced and the output voltage increases occurs. Since the collector current of the transistor 103 flows as the emitter current (graph curve 402) of the transistor 114, an action of increasing the base-emitter voltage (Vbe) of the transistor 103 occurs. That is, an action for increasing the output voltage occurs in any case.

The collector current (graph curve 401) of the transistor 109 increases in accordance with an increase of the voltages of the power supply terminals 104 and 117. A voltage at the base terminal of the transistor 114 decreases due to voltage drop in the resistor 108. The emitter current (graph curve 402) of the transistor 114 has the maximum value when the power supply voltage has a value of the vicinity of 2.8 V, and then turns to decreasing such that the emitter current of the transistor 114 does not flows when the power supply voltage has a value of the vicinity of 4 V, as illustrated in FIG. 4. That is, the transistor 114 causes the power supply voltage to be limited to being relatively low from the vicinity of two times Vbe, and thus causes an effect of increasing the output voltage to be obtained.

In the voltage generation circuit 101, when the transistor causes the current to flow, the output voltage is determined as a voltage reduced from the power supply voltage by voltage drop which occurs by the resistors. In such a voltage generation circuit, it is necessary that a power supply voltage a certain extent higher than the output voltage is applied, in order to control the output voltage to be constant. Thus, it may be difficult to control the output voltage to be constant by decreasing the power supply voltage (approaching the output voltage). For example, the voltage generation circuit 51 of the related art also has characteristics of gradually increasing the output voltage in accordance with the increase of the power supply voltage in a region of the low power supply voltage. When the circuit has such characteristics, an operation voltage range, particularly, a lower limit side of the operation voltage range becomes narrow.

Hitherto, in the voltage generation circuit 101 according to the present invention, it is possible to adjust the output voltage in the low power supply voltage region to be high (obtain the effect of increasing the output voltage in the low power supply voltage region) by a function of the transistor 109 as the above-described second bipolar transistor and a function of the transistor 114 as the third bipolar transistor. Accordingly, it is possible to reduce the power supply voltage dependency of the output voltage in the low power supply voltage region. When a power supply voltage dependency having a certain defined extent is assumed, an effect of enabling expansion of the range of an operation power supply voltage to the low power supply voltage side is obtained.

Here, an element area of the transistor 114 is set to be greater than that of the transistor 109 and the emitter current of the transistor 114 at a time of the same base voltage is increased. Thus, the action may be increased, and an “effect of increasing the output voltage” may be increased and adjusted. In this embodiment, the element area of the transistor 114 is adjusted to be 7 times the element area of other transistors.

A function of the transistor 114 will be described in detail. A case in which the collector terminal of the transistor 114 is connected to the voltage output terminal 105 is considered. In this case, the voltage drop in the resistors 106 and 107 increases due to the collector current (graph curve 402) of the transistor 114 and the above-described “effect of increasing the output voltage in the low power supply voltage region” is negated. In order to prevent negation of this effect, at least a portion of the resistive elements of the first resistor (resistors 106 and 107) is required to be not included in a path which connects the collector terminal of the transistor 114 and the power supply terminal. As in the voltage generation circuit 101, the collector terminal of the transistor 114 and the power supply terminal 117 are preferably connected to each other by using a path which does not include the first resistor.

The voltage generation circuit 101 according to the present invention further has a “configuration in which the collector terminal of the transistor 114 being the third bipolar transistor is connected to the power supply terminal 117 through the resistor 112”. An action of the “configuration in which the collector terminal of the transistor 114 is connected to the power supply terminal 117 through the resistor 112” will be described with reference to the accompanying drawing.

FIG. 5 is a diagram in which the base voltage of the fourth bipolar transistor is compared with the output voltage of the voltage generation circuit in the related art. In FIG. 5, a graph curve 501 is a graph illustrating a relationship between the base voltage (vertical axis) of the transistor 111 being the fourth bipolar transistor and the power supply voltage (horizontal axis). The graph curve 71 represents the output voltage against the power supply voltage of the voltage generation circuit 51 in the related art, which is illustrated as a comparison target. The graph curve 501 in FIG. 5 indicates values when the resistance value of the resistor 106 is set to 3200Ω. The following description will be made in comparison to the emitter current (calculation is performed by also setting the resistance value of the resistor 106 to 3200Ω in this case) of the transistor 111 illustrated in the graph curve 403 of FIG. 4.

First, ignoring of the collector current of the transistor 114 flowing in the resistor 112 is considered. At this time, a current path comprising the resistor 112, the resistor 113, the transistor 111 and the transistor 103 includes two base-emitter junctions of the transistor 111 and the transistor 103. It is considered that the base voltage of the transistor 111 has an upper rising power supply voltage dependency which is substantially the same as the base voltage (graph curve 71) of the transistor 52 which is the output voltage of the voltage generation circuit 51 in the related art.

In the practical voltage generation circuit 101, the collector current (graph curve 402) of the transistor 114 temporarily flows in the resistor 112 at the relatively low power supply voltage (2 V to the vicinity of 4 V). Thus, voltage drop by the resistor 112 increases, and the base voltage of the transistor 111 decreases in a range (2.4 V to the vicinity of 3 V), as illustrated in the graph curve 501. Since the base voltage of the transistor 111 decreases, the emitter current (graph curve 403) of the transistor 111 is reduced. In the voltage generation circuit 101, if it is assumed that the emitter current (graph curve 403) does not flow at a range from about 2.5 V to 3 V, and the graph curve 403 is bent in the vicinity of the power supply voltage of 4 V, it is considered that an influence continues to the vicinity of 4 V which causes the collector current (graph curve 402) of the transistor 114 to hardly flow.

Since the emitter current (graph curve 403) of the transistor 111 flows in the resistor 102 and thus voltage drop occurs, an action of decreasing the output voltage occurs. Decreasing of the output voltage due to the voltage drop in the resistor 102 is suppressed inversely at a period of time when the emitter current (graph curve 403) of the transistor 111 does not flow, or a period of time when flowing of the emitter current (graph curve 403) of the transistor 111 is suppressed. If the collector current (graph curve 402) of the transistor 114 does not flow and the power supply voltage increases up to the vicinity of 4 V, a current the same as the emitter current (collector current+base current) of the transistor 111 flows in the resistor 112 along with the resistor 113 and thus voltage drop occurs in accordance with the emitter current of the transistor 111. That is, it is known that the above-described effect is limited to the relatively low power supply voltage.

For example, a case in which the collector terminal of the transistor 114 is directly connected to the power supply terminal 104 without passing through the resistor 112 is considered. At the low power supply voltage corresponding to a power supply voltage having the vicinity of two times Vbe, the collector current (graph curve 403) of the transistor 111 starts to gradually increase in accordance with the increase of the power supply voltage. Since the current flows in the resistor 102, an action for decreasing the output voltage may be obtained as voltage drop in the resistor 102 and the power supply voltage dependency may be deteriorated.

In the voltage generation circuit 101 according to the present invention, decreasing of the output voltage due to the voltage drop in the resistor 102, at the low power supply voltage may be suppressed by a function of a “configuration in which the collector terminal of the transistor 114 being the third bipolar transistor is connected to the power supply terminal 117 through the resistor 112”. Thus, it is possible to further reduce the power supply voltage dependency of the output voltage in the low power supply voltage region. In other words, if the power supply voltage dependency having a certain defined extent is assumed, an effect of enabling expansion of a range of the operation power supply voltage to the low voltage side is obtained.

The voltage generation circuit 101 according to the present invention further includes the transistor 115 being the fifth bipolar transistor. An action of the transistor 115 will be described below in comparison to the emitter current (calculation is performed by setting the resistance value of the resistor 106 to 3200Ω) of the transistor 115 illustrated in the graph curve 404 in FIG. 4. In the simulation, it has employed the 3200Ω as the resistance value of the resistor 106.

In the voltage generation circuit 101, if the power supply voltage is gradually increased, a current starts to flow in the transistor 111 through the resistors 112 and 113 in the vicinity of a voltage of two times Vbe. However, as described above, the collector current (graph curve 403) of the transistor 111 starts to flow through the resistors 112 and 113 at a slightly delayed timing, when the transistor 114 cause the collector current (graph curve 402) not to flow. As described above, since the emitter current and the collector current are substantially equal to each other, descriptions will be also made by using the same graph curve for the collector current and the emitter current.

The transistor 111 connects the base terminal and the collector terminal by using the resistor 110. In a range which allows a current flowing in the resistor 110 to be ignored, the transistor 115 has a base voltage the same as that of the transistor 111. At this time, the collector currents (403 and 404) of the transistor 111 and the transistor 115 start to flow at the same timing. However, if the power supply voltage is increased, the collector current (graph curve 403) of the transistor 111 is increased and voltage drop in the resistor 110 is increased, and thus the base voltage of the transistor 115 is reduced. As illustrated in FIG. 4, the collector current (graph curve 404) of the transistor 115 is decreased after the collector current becomes the maximum value at the power supply voltage of about 4 V.

Since the collector terminal of the transistor 115 is connected to the power supply terminal 104 through the resistor 106, the collector current (graph curve 404) functions to increase the voltage drop by the resistor 106, and to decrease the output voltage at the output terminal. Since the emitter current of the transistor 115 flows into the resistor 102, the emitter current of the transistor 115 also functions to increase voltage drop in the resistor 102 and to decrease the output voltage at the output terminal.

As mentioned in the voltage generation circuit 61 of the related art, when an algebraic change (change having gradually gentle slope) of a voltage across terminals against an increase of a current in a diode or a transistor is negated by voltage drop which linearly increases in accordance with an increase of a current in a resistor, the output voltage tends to have an upwardly convex curve with an increase of the power supply voltage.

In the voltage generation circuit 101 according to the present invention, since voltage drop is caused to occur in the resistor 106 with a current (collector current of the transistor 115) having the maximum value in “the vicinity of the power supply voltage which causes the output voltage to have the maximum value” (which is described above) by a function of the transistor 111 as the fourth bipolar transistor and a function of the transistor 115 as the fifth bipolar transistor, and thus the change of the output voltage or a portion of the change of the output voltage may be negated, it is possible to provide a voltage generation circuit in which a constant output voltage is obtained in a wide range of the power supply voltage.

In order to negate the change of the output voltage, the size, the shape of the maximum value, and the timing of the maximum value shape (power supply voltage dependency) of an original output voltage and the collector current (graph curve 404) of the transistor 115 may be matched with each other as possible. Particularly, regarding the timing, the collector current (graph curve 404) of the transistor 115 preferably flows by a slightly high power supply voltage such that an increased amount of voltage drop in the resistor 106 causes the “output voltage on the low power supply voltage side, which is intentionally increased, to be reduced with the above-described configuration. A configuration of the voltage generation circuit according to the present invention, in which a current (graph curve 403) starts to flow in the transistor 111 through the resistors 112 and 113 “at the slightly delayed timing” as described above, and the current is used is preferable.

It is possible to adjust the power supply voltage dependency of the output voltage by adjusting an element size of the transistor 115 or the collector current of the transistor 115 with an emitter resistance and a base resistance, or by adjusting an amount of voltage drop corresponding to the collector current of the transistor 115 using a value of the resistor 106. It is possible to adjust a shape of the maximum value of the collector current of the transistor 115 by using the emitter resistance or the base resistance of the transistor 115. Accordingly, it is preferable that the power supply voltage dependency of the output voltage is set to be smaller. In the voltage generation circuit 101, the above adjustment is performed by using the resistor 116. From this, in the voltage generation circuit 101, with a simple configuration, a change of the power supply voltage dependency of the output voltage may be suppressed and the output voltage may be adjusted.

### Second Embodiment

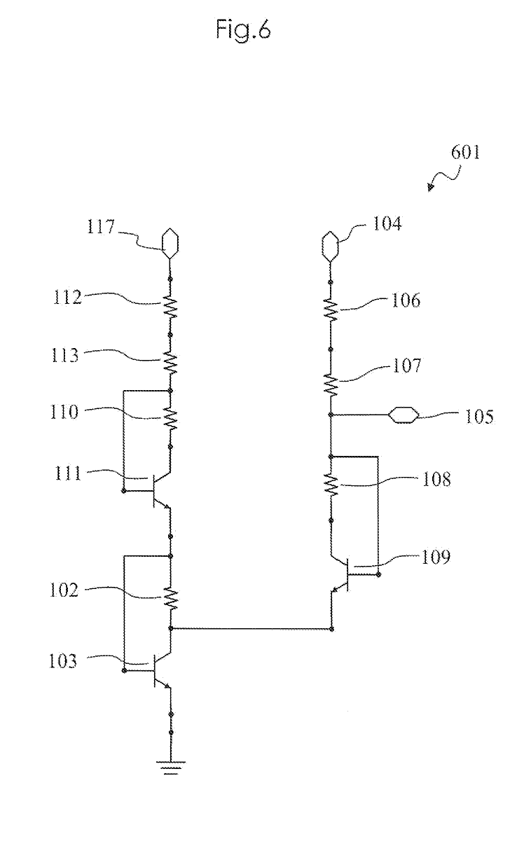

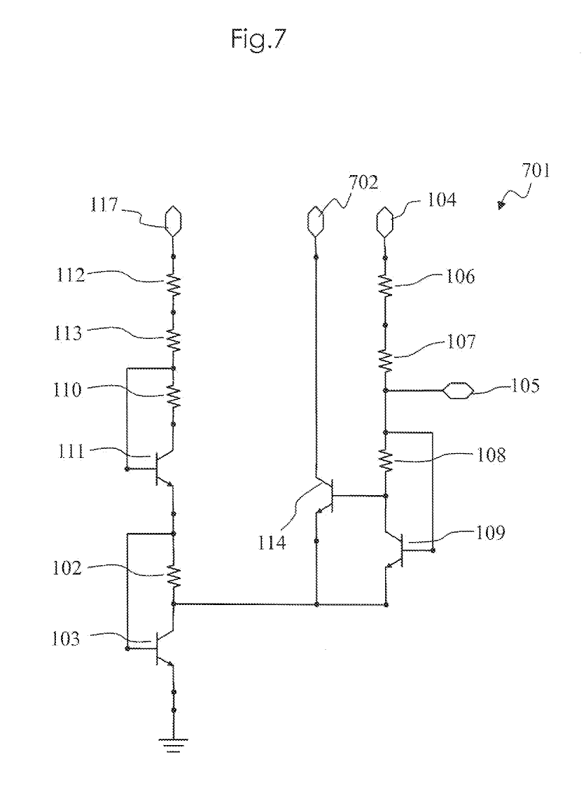

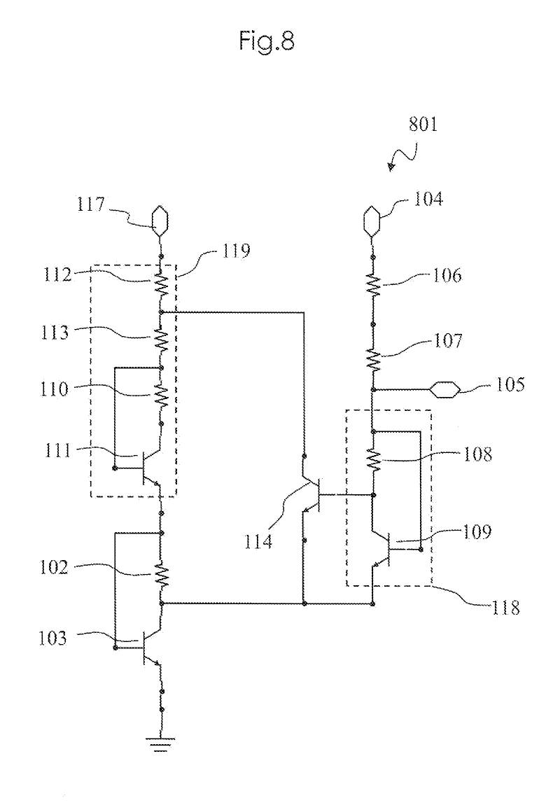

In the voltage generation circuit 101 according to the first embodiment, all elements are not required. Even though some of the elements are omitted, it is possible to obtain an effect (power supply voltage dependency of the output voltage) similar to that of the voltage generation circuit 101. A voltage generation circuit obtained by removing some component elements from the voltage generation circuit 101 will be described with reference to the accompanying drawings. FIG. 6 is a circuit diagram illustrating another example of the voltage generation circuit according to the present invention. FIG. 7 is a circuit diagram illustrating yet another example of the voltage generation circuit according to the present invention. FIG. 8 is a circuit diagram illustrating yet another example of the voltage generation circuit according to the present invention.

In the following descriptions, in order to demonstrate an operation of each of voltage generation circuits 601, 701, and 801, simulation is performed by using a model of the circuit configuration in FIGS. 6, 7 and 8, and thus a value of an output voltage and the like is calculated. FIGS. 6, 7, and 8 illustrates a circuit configured by removing some elements which constitute the voltage generation circuit 101 according to the First Embodiment. The circuit in FIGS. 6, 7, and 8 has a circuit configuration obtained by simply removing elements without a change of values of the elements in the simulation so as to perform comparison to the function of the circuit configuration which causes each action in Embodiment 1 to occur. The voltage at the power supply terminals 104, 117, and 702 (only a voltage generation circuit 701) have the same potential.

The voltage generation circuit 601 illustrated in FIG. 6 is obtained by removing the transistors 114 and 115 and the resistor 116 from the voltage generation circuit 101. That is, the voltage generation circuit 601 has the most basic configuration. The voltage generation circuit 701 illustrated in FIG. 7 has a configuration which is obtained by removing the transistor 115 and the resistor 116 from the voltage generation circuit 101 and in which the collector terminal of the transistor 114 is connected to a power supply terminal 702 without passing through the resistor 112. The power supply terminal has a potential of the same polarity as the first power supply terminal 104. When the simulation is performed for the subsequent characteristics comparison, the potential (power supply voltage) of the power supply terminal 702 is the same as the potential of the first power supply terminal 104. The voltage generation circuit 801 illustrated in FIG. 8 has a configuration obtained by removing the transistor 115 and the resistor 116 from the voltage generation circuit 101.

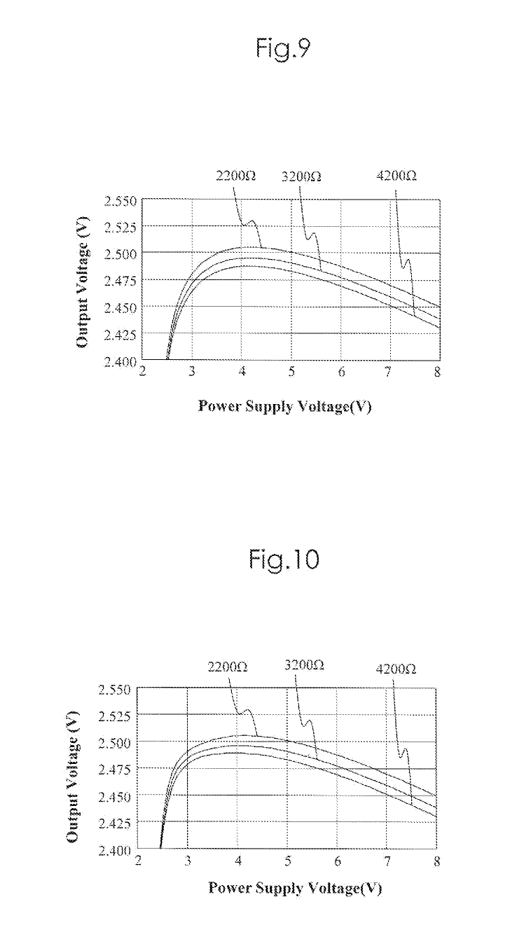

Power supply voltage dependency of an output voltage in each of the voltage generation circuits 601, 701, and 801 will be described with reference to the accompanying drawings. FIG. 9 is a diagram illustrating a relationship between the output voltage and a power supply voltage of the voltage generation circuit illustrated in FIG. 6. FIG. 9 illustrates a relationship between the output voltage (vertical axis) and the power supply voltage (horizontal axis) when the resistance value of the resistor 106 in the voltage generation circuit 601 is set to each of 2200 Ω, 3200Ω, and 4200Ω, as three graphs. The three graphs are distinguished from each other by attaching the resistance value of the resistor 106.

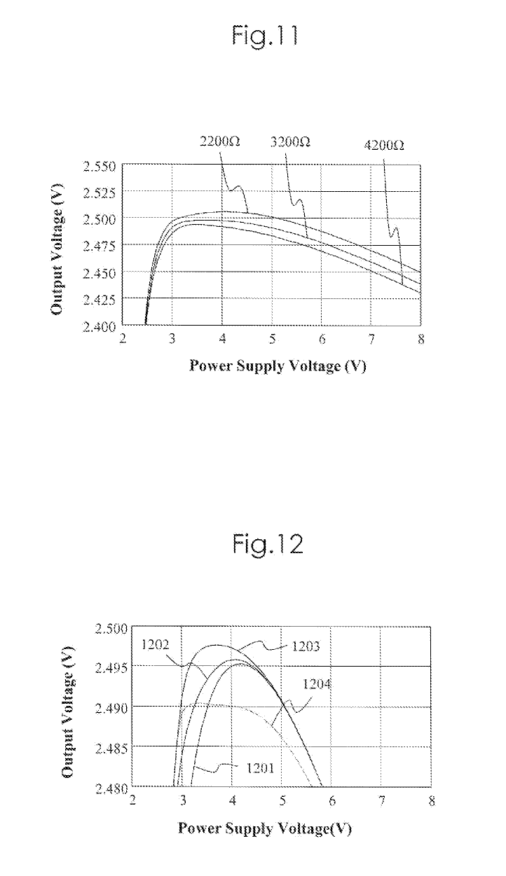

FIG. 10 is a diagram illustrating a relationship between the output voltage and the power supply voltage of the voltage generation circuit illustrated in FIG. 7. FIG. 10 illustrates a relationship between the output voltage (vertical axis) and the power supply voltage (horizontal axis) when the resistance value of the resistor 106 in the voltage generation circuit 701 is set to each of 2200 Ω, 3200Ω, and 4200Ω, as three graphs. The three graphs are distinguished from each other by attaching the resistance value of the resistor 106. FIG. 11 is a diagram illustrating a relationship between the output voltage and the power supply voltage of the voltage generation circuit illustrated in FIG. 8. FIG. 11 illustrates a relationship between the output voltage (vertical axis) and the power supply voltage (horizontal axis) when the resistance value of the resistor 106 in the voltage generation circuit 801 is set to each of 2200 Ω, 3200Ω, and 4200Ω, as three graphs. The three graphs are distinguished from each other by attaching the resistance value of the resistor 106.

As illustrated in FIGS. 9 to 11, in any one of the voltage generation circuits 601, 701, and 801, the output voltage increase in accordance with the increase of the power supply voltage and has the maximum value when the power supply voltage becomes about 4 V, and then decreases by increasing the power supply voltage. The graph curve moves in the up-and-down direction without a few change of a curve shape by changing the resistance value of the resistor 106. From this, the voltage generation circuits 601, 701, and 801 have a power supply voltage range in which the power supply voltage dependency is low. It is known that the output voltage may be adjusted by changing the resistance value of the resistor 106 such that the power supply voltage dependency is not greatly changed.

In the most basic voltage generation circuit 601 (see FIG. 9), a change of the power supply voltage dependency of the output voltage is smaller than that in the voltage generation circuit 701 (see FIG. 10), the voltage generation circuit 801 (see FIG. 11), and the voltage generation circuit 101 (see FIG. 2) when the value of the resistor 106 is changed. The power supply voltage which causes the output voltage to have the maximum value is changed a little. That is, even though the value of the resistor 106 is changed in the voltage generation circuit 601 in the basic circuit configuration illustrated in FIG. 6, a circuit configuration in which it is more difficult to have an influence on the power supply voltage dependency is obtained.

In the voltage generation circuits 701, 801, and 101, the “change of the power supply voltage dependency of the output voltage when the value of the resistor 106 is changed” is larger than that in the voltage generation circuit 601. However, a “usable range of having low power supply voltage dependency of the output voltage” becomes larger. That is, the voltage generation circuits 701, 801, and 101 have a circuit configuration in which the usable range of having low power supply voltage dependency of the output voltage is widened particularly to the low power supply voltage side by performing replacement of sacrificing the “change of the power supply voltage dependency of the output voltage when the value of the resistor 106 is changed” (in a range allowed to be used as a power generation circuit) in comparison to the voltage generation circuit 601.

A comparison of the power supply voltage dependency in the voltage generation circuits illustrated in FIGS. 6, 7, 8, and 1 will be described with reference to the accompanying drawing. FIG. 12 is a diagram obtained by enlarging peak portions of the output voltage in the voltage generation circuits illustrated in FIGS. 6, 7, 8, and 1. FIG. 12 illustrates a result obtained by performing simulation with the resistance value of the resistor 106 which is set to 3200Ω in the voltage generation circuits 601, 701, 801, and 101.

In FIG. 12, a graph curve 1201 represents an output voltage of the voltage generation circuit 601, a graph curve 1202 represents an output voltage of the voltage generation circuit 701, a graph curve 1203 represents an output voltage of the voltage generation circuit 801, and a graph curve 1204 represents the output voltage of the voltage generation circuit 101.

A comparison of the power supply voltage dependency of a current flowing in each portion in the voltage generation circuit 101 of FIG. 12 with the power supply voltage dependency of the current flowing in each portion in the voltage generation circuit 101 of FIG. 4 is considered. First, the current (graph curve 402) of the transistor 114 flows into the transistor 103 in a range of the power supply voltage from 2.5 V to 4 V. Thus, the low voltage side (2.5 V to 4 V) in the power supply voltage dependency of the output voltage (graph curve 1201) of the voltage generation circuit 601 has a little high voltage as with the output voltage (graph curve 1202) of the voltage generation circuit 701.

Then, the emitter current (graph curve 403) of the transistor 111 does not flow or is reduced at a period of time of the power supply voltage of 2.5 V to 4 V by an influence of voltage drop occurring due to the same current (graph curve 402) flowing in the resistor 112. As a result, the low voltage side (2.5 V to 4 V) in the power supply voltage dependency of the output voltage (graph curve 1202) of the voltage generation circuit 701 has higher voltage as with the output voltage (graph curve 1203) of the voltage generation circuit 801.

Lastly, voltage drop in the resistor 106 increases in accordance with a current value at a period of time (3 V to 8 V) when a value of the current (graph curve 404) flowing in the transistor 115 gradually increases so as to have the maximum value and the current flows. As a result, a change of a region (3 V to 4 V) in which the power supply voltage dependency of the output voltage (graph curve 1203) of the voltage generation circuit 801 gradually becomes the maximum value is negated. As a result, the substantially constant output voltage in a range of about 3 V to 4 V is obtained as with the output voltage (graph curve 1204) of the voltage generation circuit 101.

As described above, the voltage generation circuits 101, 601, 701, and 801 have slightly different characteristics. However, in all of the voltage generation circuits 101, 601, 701, and 801, it is possible to suppress the power supply voltage dependency of the output voltage so as to be low and to change the output voltage without a large change of the power supply voltage dependency.

### Third Embodiment

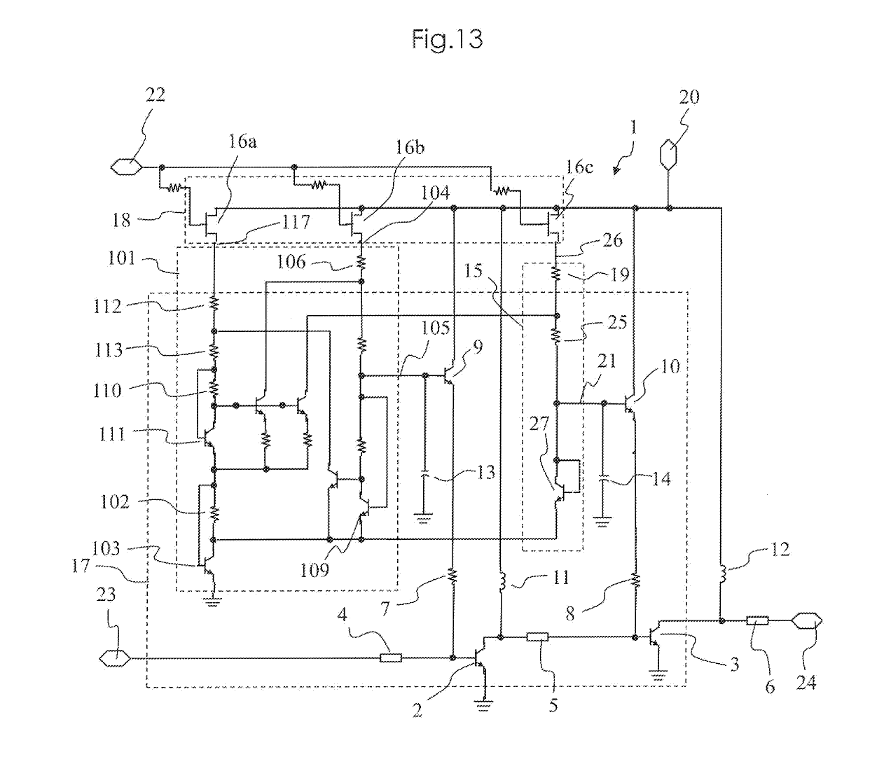

An example of a circuit using the voltage generation circuit according to the present invention will be described with reference to the accompanying drawing. FIG. 13 is a circuit diagram illustrating an example of a power amplification circuit using the voltage generation circuit according to the present invention.

As illustrated in FIG. 13, a power amplification circuit 1 includes amplification transistors 2 and 3, an input matching circuit 4, an inter-stage matching circuit 5, an output matching circuit 6, ballast resistors 7 and 8, bias transistors 9 and 10, choke coils 11 and 12 for cutting a high frequency, capacitors 13 and 14 for cutting a high frequency, voltage generation circuits 101 and 15, and field effect transistors 16 (16a, 16b, and 16c) for control. The capacitors 13 and 14 for cutting a high frequency is used for preventing an input of a high frequency signal to the voltage generation circuit.

When a circuit surrounded by a dashed line 17 is configured as an integrated circuit by using hetero-junction bipolar transistors (NPN type bipolar transistors), a configuration according to the present invention, in which a PNP type element are not necessary is important since normally, a transistor element is configured by only an NPN transistor. Descriptions will be made by using an example in which the field effect transistor 16 for control is configured as a portion of an integrated circuit 18 which is configured by normally-ON type hetero-junction field effect transistors and, 106 and 19 are configured by using chip resistor components for adjusting a voltage. The hetero-junction field effect transistor is a general component which is much used as a high frequency switch circuit in a state of being adjacent to a high frequency amplification circuit.

The power supply voltage which has been applied to a power supply terminal 20 is applied to each of collector terminals of the amplification transistors 2 and 3 through the choke coils 11 and 12. In the bias transistors 9 and 10, a collector terminal is connected to the power supply terminal 20, and the base terminal is connected to voltage output terminals 105 and 21 of the circuits 101 and 15. A configuration in which base currents of the amplification transistors 2 and 3 are respectively supplied via the ballast resistors 7 and 8 when a voltage of about 2.5 V is applied to the voltage output terminals 105 and 21 is obtained.

The field effect transistor 16 for control turns ON and OFF by a signal of a control terminal 22, and thus a voltage of each of power supply terminals 117, 104, and 26 in the voltage generation circuits 101 and 15 is changed and an operation in the entirety of the circuit is controlled. A high frequency signal input from the input signal terminal 23 is amplified by the amplification transistor 2 via an input matching circuit 4. In the inter-stage matching circuit 5, impedance matching is performed. Further amplification is performed in the amplification transistor 3 and a result of further amplification is output from the output signal terminal 24 via the output matching circuit 6.

The voltage generation circuit 15 is configured from resistors 19 and 25, and a transistor 27, similarly to the resistors 106 and 107, and the transistor 109 in the voltage generation circuit 101. An emitter terminal of the transistor 27 is connected to the collector terminal of the transistor 103 and a base terminal of the transistor 27 is set as the voltage output terminal 21.

The power supply terminal 26 is a power supply terminal having the same potential as the power supply terminal 104 which is the first power supply terminal. The voltage output terminal 21 is a second voltage output terminal, the resistors 19 and 25 are a fifth resistor. The transistor 27 constitutes a third connection circuit, and connection is performed such that a forward junction voltage of a base-emitter junction is generated between the second voltage output terminal and the collector terminal of the transistor 103 in accordance with the emitter current of the transistor.

That is, the voltage generation circuit 15 describes a configuration in which a common terminal is set by using the voltage at the collector terminal of the transistor 103 and a voltage output separate from that at the voltage output terminal 105 in the voltage generation circuit 101 is obtained at a terminal 21. Here, an output voltage at the terminal 21 may be adjusted to be a value separate from the output voltage at the terminal 105 by changing resistance values of the resistors 19 and 25.

If comparison to a case of using the voltage generation circuits 51 and 61 in the related art is performed, many circuit elements are included by using the voltage generation circuit 101 according to the present invention. However, since a portion of the voltage generation circuit may be shared by combining the voltage generation circuit 15 with the voltage generation circuit 101 according to the present invention and by using a result of combination, there are the following advantages in application to a circuit having a necessity for obtaining a plurality of voltage outputs, like a multi-stage amplification circuit. That is, it is possible to suppress an increase of the number of circuit elements, to reduce the size of the circuit, and to individually set a base bias voltage of each amplification transistor.

Since a voltage to be applied to the power supply terminal is supplied from a battery in a portable terminal and the like, the circuit has a necessity for performing a stable operation against fluctuation of the voltage. Accordingly, in the related art, a constant voltage is generated in a regulator circuit and the like and a power amplification integrated circuit which is formed from hetero-junction bipolar transistors which are amplification elements is operated. It is possible to provide a high frequency power amplification circuit in which a stable amplification operation against fluctuation of the power supply voltage is also enabled with a simple configuration in which the power supply voltage simply causes the field effect transistor 9 to turn ON and OFF, by using a voltage generation circuit having low power supply voltage dependency of the output voltage, like the voltage generation circuit 101 according to the present invention.

It is possible to provide a high frequency power amplification circuit in which a stable amplification operation against voltage fluctuation of the power supply voltage is also enabled with a simple configuration in which the voltage at the power supply terminals 117, 104, and 26 simply causes the field effect transistor 9 to turn ON and OFF, by using the voltage generation circuit 101 according to the present invention, which has low power supply voltage dependency of the output voltage. Since the output voltage of the voltage generation circuit can be easily adjusted, and a gain of the amplification circuit can be adjusted by using the resistors 106 and 19 for adjustment, it is also possible to improve versatility, for example, the same integrated circuit chip may be used in different uses.

In the amplification circuit 1 according to this embodiment, using of normally-ON type field effect transistors as the field effect transistors 16a, 16b, and 16c is appropriate. As described above, when the field effect transistors 16a, 16b, and 16c for control are formed as a portion of the integrated circuit 17 including a high frequency switch and the like, the high frequency switch is normally configured by normally-ON type field effect transistors having a pinch-off voltage of about −0.5 V to −1.3 V. When this element is used for control, a “voltage obtained by multiplying the pinch-off voltage by −1”, that is, a voltage of about 0.5 V to 1.3 V is applied to the power supply terminals 117, 104, and 26 even though a gate voltage is set to 0 V.

At this time, since there are two junction elements (base-emitter junction) on current paths from base terminals of the bias transistors 9 and 10 to ground terminals via base terminals of the amplification transistors 2 and 3, from the power supply terminal, a current does not flow until a voltage of substantially two times a junction barrier of a junction element, here, a voltage of equal to greater than about 2.4 V is applied. Accordingly, the circuit may be caused to turn ON and OFF by using the above-described voltage (0.5 V to 1.3 V).

In the voltage generation circuit 101, two junction elements of the transistors 111 and 103 are provided on a current path from the power supply terminal 117. Two junction elements of the transistors 109 and 103 are provided on a current path from the power supply terminal 104. Two junction elements of the transistors 27 and 103 are provided on a current path from the power supply terminal 26. From this, since two junction element are also provided on each of all of current paths from the power supply terminals to the ground terminals in the voltage generation circuit, the current does not flow and thus it is possible to suppress consumption of a remaining current at a time when the circuit is OFF. In the voltage generation circuits 51 and 61 of the related art, there is a path from the power supply terminal to the ground terminal via the transistor 52 and the resistor 55, and thus it is impossible to cause the circuit to completely be off with the above-described voltage (0.5 V to 1.3 V).

For example, even though a battery is discharged, the power supply voltage is reduced to 3 V, and thus a voltage of only 1.7 V to 2.5 V is applied to a gate of the field effect transistor 9 for control, if the above normally-ON field effect transistor is used, an ON state occurs and thus a voltage of 3 V which is substantially the same as the power supply voltage may be applied to the power supply terminals 117, 104, and 26.

Normally-OFF field effect transistors (pinch-off voltage is in a range of 0.3 V to 0.5 V) are used as the field effect transistors 16a, 16b, and 16c for control. In this case, even though a gate voltage is set to be the same as the power supply voltage of 3 V, a voltage applied to the voltage generation circuit 101 is in a range of 2.5 V to 2.7 V. In an integrated circuit configured by hetero-junction bipolar transistors (NPN bipolar transistors) in which about 2.5 V is required for the base voltage of the bias transistors 9 and 10, a voltage of 2.7 V to 2.8 V is required as the lowest voltage. It is difficult to perform a stable operation with the above-described voltage.

It is possible to provide a high frequency amplification circuit in which a regulator circuit is unnecessary and control is enabled by simple ON/OFF of power, by using the voltage generation circuit 101 according to the present invention. Particularly, it is possible to use a normally-ON type field effect transistor in control of the voltage generation circuit and to provide a high frequency amplification circuit in which performing of an operation is enabled with lower power supply voltage, by using the voltage generation circuit in which two or more junction elements are provided on the current path.

In the amplification circuit of FIG. 13, the field effect transistors 16a, 16b, and 16c are respectively disposed at the power supply terminals 117, 104, and 26, and the power supply terminals 117, 104, and 26 are configured so as to be terminals which are separate from each other and have the same potential, and to which most of the power supply voltage is applied as it is. However, it is not limited thereto, and a configuration in which control is performed with a single field effect transistor obtained by connecting the power supply terminals 117, 104, and 26 to each other may be obtained. In the power amplification circuit 1 according to this embodiment, a configuration in which the voltage generation circuit 101 according to the present invention is incorporated is described. However, it is not limited thereto, and any one of the voltage generation circuits 601, 701, and 801 may be incorporated.

### Modification Example

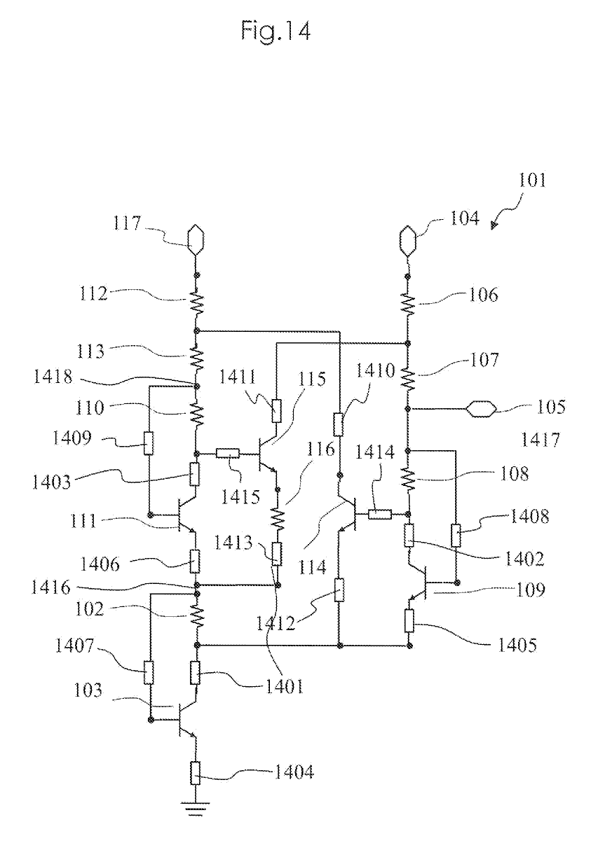

A modification example of the voltage generation circuit according to the present invention will be described with reference to the accompanying drawings. FIG. 14 is a diagram illustrating connection portions with terminals of the first bipolar transistor, a second bipolar transistor, and the fourth bipolar transistor in the voltage generation circuit illustrated in FIG. 1. Referring to FIG. 14, an influence on the circuit when connections 1401 to 1409 to the terminals of the transistors 103, 109, and 111 are set as connections by the resistors is investigated by using the voltage generation circuit 101 as an example. A necessary configuration for the present invention or a replaceable configuration will be described.

First, a case in which connections 1401, 1402, and 1403 to the collector terminal of the transistor are set as connections by the resistor will be described. In this circuit, performing of an operation is enabled. However, since characteristics of performing an operation are used in the configuration of the present invention even though the voltage at the collector terminal is slightly smaller than the voltage at the base terminal, a margin of the collector voltage which allows the transistor to be operated is reduced by voltage drop in the resistor and thus the power supply voltage range which allows the circuit to be operated is narrow. Thus, there are many cases which are not preferable.

Then, when connections 1404 and 1405 to the emitter terminals of the transistors 103 and 109 are set as connections by the resistor, since the voltage drop by the resistor increase with an increase of the power supply voltage, a function of increasing a voltage at the voltage output terminal along with the power supply voltage is performed. This function is not preferable considering the present invention causes an action of decreasing the voltage at the voltage output terminal along with the power supply voltage by using the function of the voltage drop in the resistor 102. However, an influence of the resistor at the connections 1404 and 1405 may be negated by increasing the resistance value of the resistor 102 up to a certain extent. When the connection 1405 is set as a connection by the resistor, since an influence is applied to the voltage at the base terminal of the transistor 114, adjustment may be required such that the influence is negated by increasing a resistance value of the resistor 108.

When a connection 1406 to the emitter terminal of the transistor 111 is set as a connection in the resistor, the resistor has the same function as the resistor 113. If it is considered that the transistor 115 and the resistor 116 are removed from FIG. 14, since the transistor 111 causes the base terminal to function as a diode to which the collector terminal is connected, and the resistor 113 and the connection 1406 are connected in series to the diode, the function is the same. However, if the connection 1406 has a resistance value, since the voltage at the base terminal of the transistor 115 causes voltage drop in the resistor to be increased, adjustment may be required such that the voltage drop in the resistor is negated by increasing the resistance value of the resistor 110.

Connections 1407, 1408, and 1409 to the base terminals of the transistors 103, 109, and 111 have substantially the same function as the connections 1404, 1405, and 1406 to the emitter terminals of the transistors 103, 109, and 111. However, since the base current is 1/β of the collector current and the emitter current is summation of the base current and the collector current, the resistor connected to the base terminal has an influence smaller than that of the resistor connected to the emitter terminal. If the resistor when the resistor is connected to the emitter terminal has a resistance value of ((β+1) times and is connected to the terminal, an influence is substantially the same. In this case, adjustment is also required such that an influence of the resistors 102, 108, and 110 is negated. However, increasing of the resistors 102, 108, and 110 causes the voltage at the collector terminal to decrease marginally, similarly to connection of the connections 1401, 1402, and 1403 by using the resistor, and thus the operation voltage range becomes narrower. Accordingly, increasing of the resistors 102, 108, and 110 is not preferable in some cases.

The resistor 102 between the base and the collector of the transistor 103 being the first bipolar transistor will be described. In the voltage generation circuit 101, an effect of relieving the power supply voltage dependency in accordance with the value of the resistor 102 is obtained. If the connections 1404 and 1407 are set as connection by the resistor, the power supply voltage dependency is deteriorated by the connection 1404 and the connection 1407. However, deterioration of the power supply voltage dependency is suppressed by the effect of relieving the power supply voltage dependency in accordance with the value of the resistor 102.

At this time, a resistance value of the first connection path between a “terminal 1416 (first connection terminal) to which the emitter terminal of the transistor 111 is connected” and “the second terminal in the first circuit” in the first connection path from the base terminal of the transistor 103 to the collector terminal via the connection 1407, the resistor 102, and the connection 1401 functions as a resistor having an effect. The “second terminal in the first circuit” is necessarily connected to the first connection path between the “first connection terminal 1416” and the collector terminal of the transistor 103. In the above descriptions, since the power supply voltage dependency is deteriorated, it is preferable that the connections 1404 and 1407 are not set as connections by resistors.

On the other hand, regarding the resistor 108 between the base and the collector of the transistor 109 being the second bipolar transistor, the presence of only the resistor is insufficient and voltage drop in the resistor is negated by using an emitter resistance or a base resistance, and the base-emitter voltage of the transistor 114 is required to be set to be lower than the base-emitter voltage of the transistor 109. Thus, since voltage drop increases with an increase of the collector current of the transistor 109, as described above, the collector current of the transistor 114 flows with the low power supply voltage, the collector current has the maximum value with an increase of the power supply voltage, and then the collector current decreases.

At this time, a resistance value of the second connection path between a “terminal 1417 (second connection terminal) which is connected to the resistor 107 being the first resistor” and the “base terminal of the transistor 114” in the second connection path from the base terminal of the transistor 109 to the collector terminal via the connection 1408, the resistor 108, and the connection 1402 functions as a resistor having an effect. The “base terminal of the transistor 114” is necessarily connected to the second connection path between the “second connection terminal 1417” and the collector terminal of the transistor 109.

In the same manner, regarding the resistor 110 between the base and the collector of the transistor 111 being the fourth bipolar transistor, the presence of only the resistor is insufficient and voltage drop in the resistor is not negated by using an emitter resistance or a base resistance, and the base-emitter voltage of the transistor 115 is required to be set to be lower than the base-emitter voltage of the transistor 111. Thus, since voltage drop increases with the increase of the collector current of the transistor 111, as described above, the collector current of the transistor 115 flows with the low power supply voltage, the collector current has the maximum value with an increase of the power supply voltage, and then the collector current turns to decreasing.

At this time, a resistance value of the third connection path between a “terminal 1418 (third connection terminal) which is connected to the power supply terminal” and the “base terminal of the transistor 115” in the third connection path from the base terminal of the transistor 111 to the collector terminal via the connection 1409, the resistor 110, and the connection 1402 functions as a resistor having an effect. The “base terminal of the transistor 115” is necessarily connected to the third connection path between the “third connection terminal 1418” and the collector terminal of the transistor 111.

In connections 1410, 1411 to the collector terminals of the transistors 114 and 115, if the collector terminal is connected to the power supply terminal having a potential higher than the base terminal, the transistor operation (amplification operation) may be performed. Even though the connection in the resistor is replaced with the connection, a large influence on the circuit operation may be not generated. Connections 1412 and 1413 to the emitter terminal or connections 1414 and 1415 to the base terminal may be used in adjustment so as to decrease the emitter current of the transistor. In this case, if a resistor having the resistance value when the resistor is connected to the base terminal, which is reduced to substantially 1/((β+1) is connected to the emitter terminal, an influence is substantially the same. In the connections to the emitter terminal or the connections to the base terminal, since a timing at which the emitter current flows for the power supply voltage is changed a little, the connections may be used in adjustment such that the power supply voltage dependency of the output voltage becomes smaller.

When the voltage at the collector terminal of the transistor is not used for another control voltage like the second transistor 109 in the voltage generation circuit 601, and the fourth transistor 111 in the voltage generation circuits 601 and 701, the resistors 108 and 110 are unnecessary and the transistor may be considered as a two-terminal diode in which a base terminal and a collector terminal are connected.

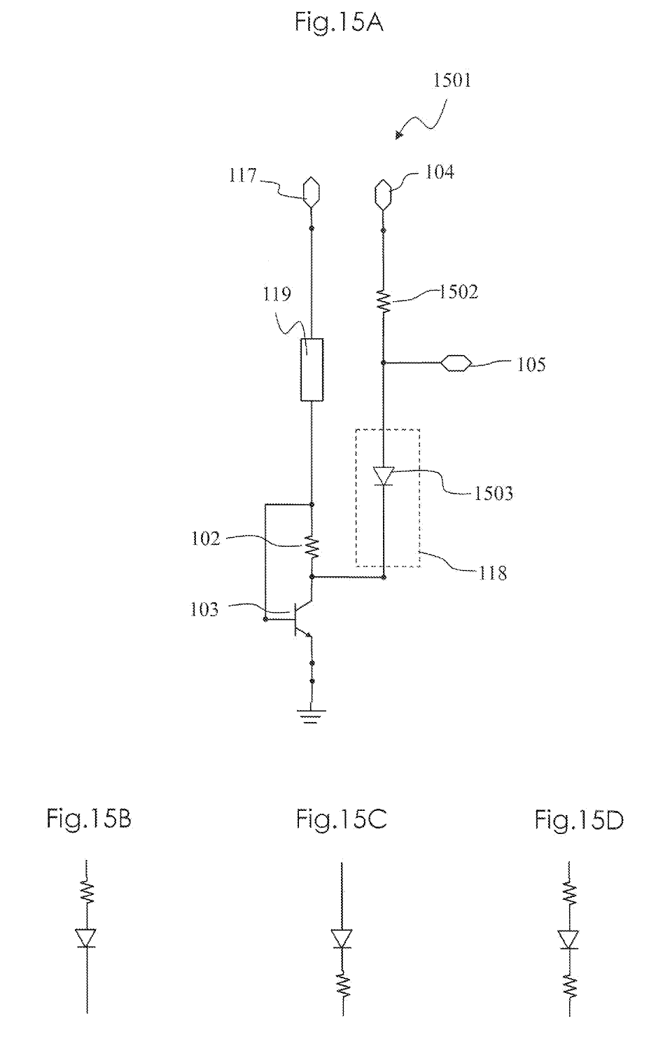

For example, the circuit 601 may be obtained by performing replacement with a diode like the voltage generation circuit 1501 illustrated in FIG. 15A. FIG. 15A is a diagram illustrating yet another example of the voltage generation circuit according to the present invention. In the voltage generation circuit 1501, a resistor 1502 is the first resistor and a diode 1503 constitutes the first circuit 118. Since the second circuit 119 is a series circuit of a diode and a resistor, as illustrated in FIG. 15B, FIG. 15C, and FIG. 15D, even though an order of the diode 1504 and the second resistor is changed or a plurality of elements obtained by dividing the second resistor with a certain ratio are disposed on an upper side and a lower side of the diode, an equivalent circuit is obtained and the obtained circuit may be used as the configuration of the present invention.

When replacement with a diode is performed, in the first circuit, a junction voltage of a diode junction in the forward direction is generated between the first terminal and the second terminal of the first circuit, in accordance with a diode current. In the second circuit, the summation of the “junction voltage of the diode junction in the forward direction” and the “voltage drop by the resistor” is generated between the first terminal and the second terminal of the second circuit, in accordance with a diode current.

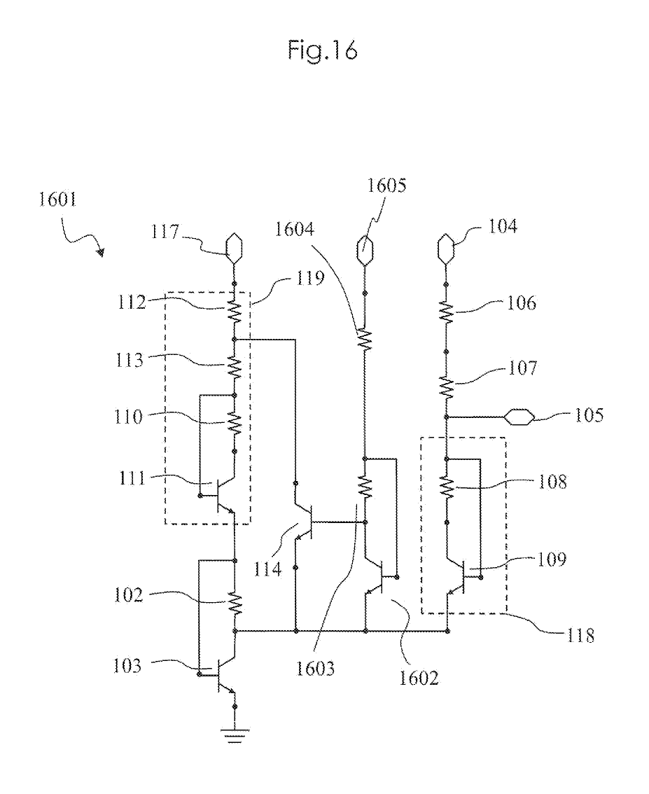

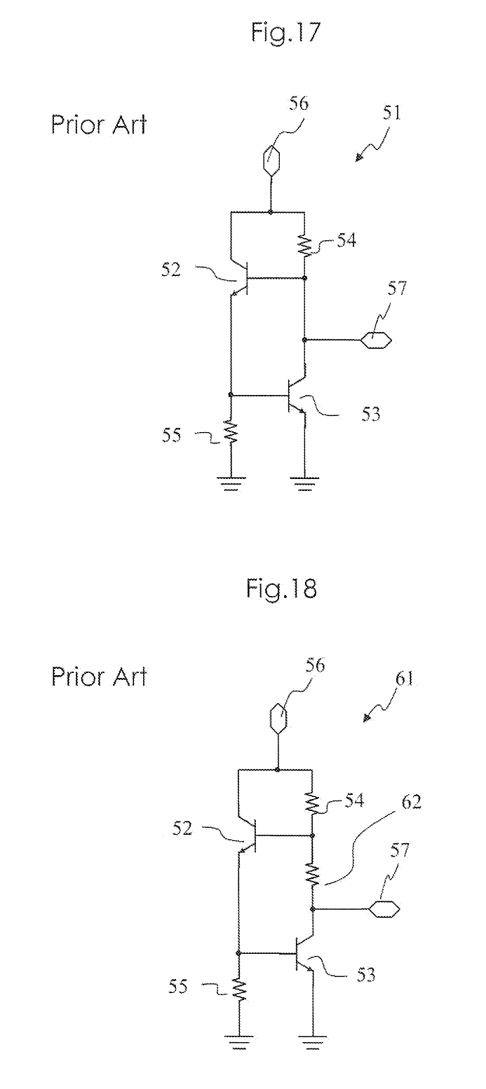

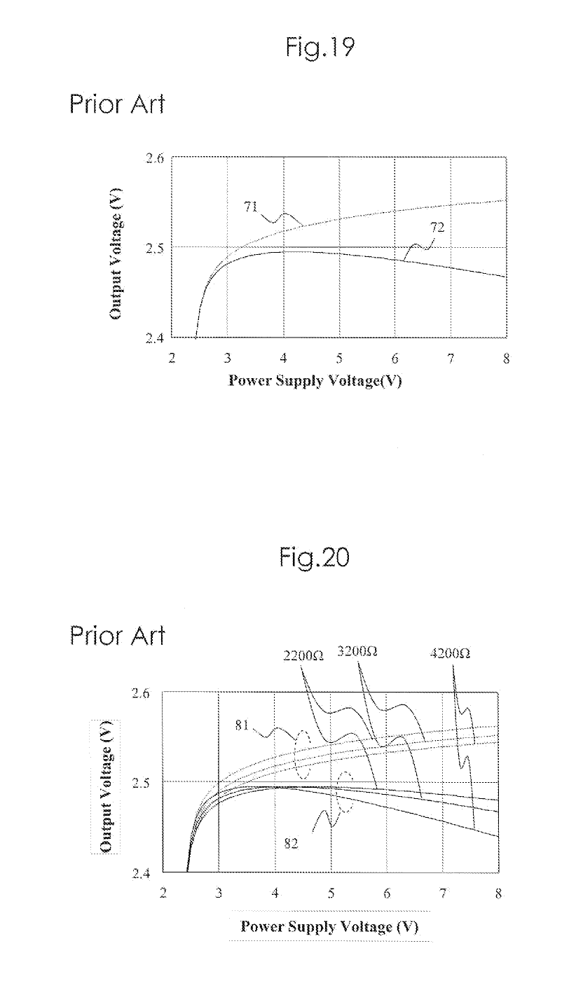

In the voltage generation circuits 701, 801, and 101, an example in which the bipolar transistor element and the second bipolar transistor of the first circuit are configured by using the common transistor 109 is described. However, as in a circuit 1601 of FIG. 16, the bipolar transistor element and the second bipolar transistor of the first circuit may be configured by using individual junction elements. FIG. 16 is a circuit diagram illustrating a modification example of the voltage generation circuit illustrated in FIG. 8. In the voltage generation circuit 1601 illustrated in FIG. 16, a transistor 1602 is disposed as the second bipolar transistor so as to be separate from the first circuit 118, the base terminal and the collector terminal are connected by using a resistor 1603, and the base terminal of the transistor 114 being the third bipolar transistor is connected to the collector terminal of the transistor 1602. The base terminal of the second bipolar transistor is connected to a power supply terminal 1605 by using a resistor 1604 and a power source 1605 becomes a power supply terminal having the same potential as the first power supply terminal.

If the voltage generation circuit 801 and the voltage generation circuit 1601 are compared to each other, the voltage generation circuit 801 has an advantage of a little simplified circuit configuration for causing the first circuit and the second bipolar transistor to be configured by the common element, in comparison to the voltage generation circuit 1601. If a circuit operation is compared, when a current is drawn from the voltage output terminal 105, it is known that the voltage generation circuit 801 has properties in that decreasing of the voltage at the voltage output terminal is difficult at the low power supply voltage. It is known that a reason is because a relative decrease of a current in the first circuit occurs when the current is drawn from the voltage output terminal in the circuit 801, a decrease of the collector current of the transistor 109 causes the voltage drop by the resistor 108 to become small, causes the base voltage of the transistor 114 to increase, the current of the transistor 114 flows, and thus feedback is performed in a direction in which the voltage at the voltage output terminal rises. In the circuit 1601, when the current is drawn from the voltage output terminal, even though a decrease of the current of the first circuit occurs, the base voltage of the transistor 114 does not increase, and the effect as described above is not obtained. That is, it is known that the circuit in which the first circuit and the second transistor are shared has an advantage of an inner resistor in a reference voltage source becoming smaller.

Hitherto, the embodiments according to the present invention are described. However, the present invention is not limited to the details of the embodiments. Various modifications may be added to the embodiment according to the present invention in a range without departing from the gist of the invention.

### INDUSTRIAL APPLICABILITY

The present invention may be widely employed as a voltage supply source for an electronic circuit such as a portable phone and a communication device, which has a necessity that a voltage having low power supply dependency is supplied to the output voltage even though the power supply voltage fluctuates.

### REFERENCE SIGNS LIST

103 FIRST TRANSISTOR
109, 1602 SECOND TRANSISTOR
118 FIRST CIRCUIT
119 SECOND CIRCUIT
27 THIRD CIRCUIT
106, 107, 1502 FIRST RESISTOR
112, 113 SECOND RESISTOR
112 THIRD RESISTOR
106 FOURTH RESISTOR
19, 25 FIFTH RESISTOR
104 FIRST POWER SUPPLY TERMINAL
117, 1605 POWER SUPPLY TERMINAL HAVING SAME POTENTIAL AS FIRST POWER SUPPLY TERMINAL
702 POWER SUPPLY TERMINAL HAVING SAME POLARITY AS FIRST POWER SUPPLY TERMINAL
105 FIRST VOLTAGE OUTPUT TERMINAL
22 SECOND VOLTAGE OUTPUT TERMINAL
109, 1402 SECOND TRANSISTOR
114 THIRD TRANSISTOR
111 FOURTH TRANSISTOR
115 FIFTH TRANSISTOR
2, 3 AMPLIFICATION TRANSISTOR
7, 8 BALLAST RESISTOR
4, 5, 6 MATCHING CIRCUIT
24 INPUT TERMINAL
25 OUTPUT TERMINAL
23 CONTROL TERMINAL
16 FIELD EFFECT TRANSISTOR FOR CONTROL

1-5. (canceled)

6. A voltage generation circuit comprising:
a first power supply terminal; a first voltage output terminal; a first resistor; a first bipolar transistor; a first circuit; and a second circuit,
wherein an emitter terminal of the first bipolar transistor is connected to a ground terminal,
a base terminal and a collector terminal of the first bipolar transistor are connected to each other by a first connection path, and a first connection terminal is provided on the first connection path,
a first terminal of the first circuit is connected to the first power supply terminal through the first resistor;
a second terminal of the first circuit is connected to the first connection path between the first connection terminal and the collector terminal of the first bipolar transistor,
a resistor is provided on the first connection path between the second terminal of the first circuit and the first connection terminal,
the first circuit is one of
a circuit which has a diode and generates a forward junction voltage of diode junction between the first terminal of the first circuit and the second terminal of the first circuit in accordance with a current flowing in the diode and
a circuit which has a bipolar transistor of which a base and a collector are connected to each other and generates a forward junction voltage of a base-emitter junction between the first terminal of the first circuit and the second terminal of the first circuit in accordance with an emitter current,
a first terminal of the second circuit is connected to one of the first power supply terminal and a power supply terminal having the same potential as the first power supply terminal,
a second terminal of the second circuit is connected to the first connection terminal,
the second circuit is one of
a circuit which has a diode and a second resistor and generates summation of a forward junction voltage of diode junction and voltage drop by the second resistor between the first terminal of the second circuit and the second terminal of the second circuit in accordance with a current flowing in the diode and
a circuit which has a bipolar transistor of which a base and a collector are connected to each other and a second resistor and generates summation of a forward junction voltage of a base-emitter junction and voltage drop by the second resistor between the first terminal of the second circuit and the second terminal of the second circuit in accordance with an emitter current,
in the voltage generation circuit, connection is performed such that a polarity of the base-emitter junction in the first bipolar transistor has a forward direction for the power supply voltage of the power supply terminal, and
the voltage output terminal is connected to the first terminal of the first circuit.

7. The voltage generation circuit according to claim 6, further comprising:
a second bipolar transistor; and a third bipolar transistor,
wherein a base terminal and a collector terminal of the second bipolar transistor are connected by a second connection path, and a second connection terminal is provided on the second connection path,
the second connection terminal is connected to one of the first power supply terminal and a power supply terminal having the same potential as the first power supply terminal through a resistor,
an emitter terminal of the second bipolar transistor is connected to the first connection path between the first connection terminal and the collector terminal of the first bipolar transistor,
a resistor is provided on the first connection path between the emitter terminal of the second bipolar transistor and the first connection terminal,
a collector terminal of the third bipolar transistor is connected to one of the first power supply terminal and a power supply terminal having the same polarity as the first power supply terminal, and at least some of resistive elements constituting the first resistor are not included on a path of the connection,
an emitter terminal of the third bipolar transistor is connected to the first connection path between the first connection terminal and the collector terminal of the first bipolar transistor,
a resistor is provided on the first connection path between the emitter terminal of the third bipolar transistor and the first connection terminal,
a base terminal of the third bipolar transistor is connected to the second connection path between the second connection terminal and the collector terminal of the second bipolar transistor,
a resistor is provided on the second connection path between the base terminal of the third bipolar transistor and the second connection terminal,
in the voltage generation circuit, connection is performed such that both of a polarity of the base-emitter junction in the second bipolar transistor and a polarity of a base-emitter junction in the third bipolar transistor have a forward direction for the power supply voltage of the power supply terminal, and
a resistance value of a resistor on the second connection path between the base terminal of the third bipolar transistor and the second connection terminal is set such that a base-emitter voltage of the third bipolar transistor is smaller than a base-emitter voltage of the second bipolar transistor.

8. The voltage generation circuit according to claim 7, further comprising:
a third resistor,
wherein the collector terminal of the third bipolar transistor is connected to one of the first voltage output terminal and a power supply terminal having the same potential as the first voltage output terminal through the third resistor and
the second resistor and the third resistor have at least a portion as a common resistor.

9. The voltage generation circuit according to claim 8, further comprising:
a fifth bipolar transistor and a fourth resistor,
wherein the second circuit has a fourth bipolar transistor having a collector terminal and a base terminal connected by a third connection path, the second resistor, and a third connection terminal on the third connection path,
the second circuit is a circuit which generates summation of a forward junction voltage of a base-emitter junction in the fourth bipolar transistor and voltage drop by the second resistor between the first terminal and the second terminal in accordance with an emitter current,
the fifth bipolar transistor has a collector terminal connected to the first power supply terminal through the fourth resistor,
an emitter terminal of the fifth bipolar transistor is connected to the first connection terminal, and a base terminal of the fifth bipolar transistor is connected to the third connection path between the third connection terminal and the collector terminal of the fourth bipolar transistor,
a resistor is provided on the third connection path between the base terminal of the fifth bipolar transistor and the third connection terminal,
the first resistor and the fourth resistor have at least a portion as a common resistor,
in the voltage generation circuit, connection is performed such that a polarity of a base-emitter junction in the fifth bipolar transistor has a forward direction for the power supply voltage of the power supply terminal, and
a resistance value of the resistor on the third connection path between the base terminal of the fifth bipolar transistor and the third connection terminal is set such that a base-emitter voltage of the fifth bipolar transistor is smaller than a base-emitter voltage of the fourth bipolar transistor.

10. The voltage generation circuit according to claim 9, further comprising in the voltage generation circuit according to claim 9: a second voltage output terminal; a third circuit; and a fifth resistor,
wherein a first terminal of the third circuit is connected to one of the first power supply terminal and a power supply terminal having the same potential as the first power supply terminal through the fifth resistor,
a second terminal of the third circuit is connected to the first connection path between the first connection terminal and the collector terminal of the first bipolar transistor,
a resistor is provided on the first connection path between the second terminal of the third circuit and the first connection terminal,
the third circuit is one of
a circuit which has a diode and generates a forward junction voltage of diode junction between the first terminal of the third circuit and the second terminal of the third circuit in accordance with a current flowing in the diode, and
a circuit which has a bipolar transistor in which a base and a collector are connected to each other and generates a forward junction voltage of a base-emitter junction between the first terminal of the third circuit and the second terminal of the third circuit in accordance with an emitter current, and
the second voltage output terminal is connected to the first terminal of the third circuit.
